(19) United States
(12) Patent Application Publication
(10) Pub. No.: US 2025/0324293 A1
(43) Pub. Date: Oct. 16, 2025

(54) PERCEPTION-AIDED WIRELESS COMMUNICATIONS

(71) Applicant: QUALCOMM Incorporated, San Diego, CA (US)

(72) Inventors: In-Soo KIM, San Diego, CA (US); Hussein METWALY SAAD, San Diego, CA (US); Yann LEBRUN, Velizy-Villacoublay (FR); Simone MERLIN, San Diego, CA (US); Peerapol TINNAKORNSRISUPHAP, San Diego, CA (US)

(21) Appl. No.: 18/636,682

(22) Filed: Apr. 16, 2024

(51) Int. Cl. H04W 24/08; H04L 41/16; H04W 24/10

(52) U.S. Cl. CPC H04W 24/08; H04L 41/16; H04W 24/10

(57) ABSTRACT

Certain aspects of the present disclosure provide techniques for perception-aided wireless communications. An example method for wireless communications by an apparatus includes obtaining a first configuration that indicates to predict at least one channel property, based at least in part on perception information, using a first machine learning (ML) model; communicating, via at least one communication channel, based at least in part on a prediction of one or more channel properties associated with the at least one communication channel, wherein the prediction of the one or more channel properties is obtained via the first ML model; and sending an indication of one or more performance metrics associated with predicting the one or more channel properties via the first ML model.

### INTRODUCTION

### Field of the Disclosure

Aspects of the present disclosure relate to wireless communications, and more particularly, to techniques for wireless communications using perception information.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In certain cases, a wireless communication device (e.g., a user equipment (UE)) may have access to perception information that provides an awareness of an environment in which the device is located. The perception information may indicate one or more characteristics associated with the environment, such as the position and/or orientation of the device, the position of another wireless device (e.g., a base station), and/or the position and/or size of object(s) or structure(s) (that may influence wireless communications with the device). A UE may use the perception information to assist with communicating via a wireless communication channel, for example, for radio resource management. In some cases, a relationship between the perception information and a wireless communication channel may be characterized via artificial intelligence (AI), such as machine learning (ML). For example, an ML model may be trained to predict certain channel properties associated with a communication link given perception information as input to the ML model.

As an ML model may be trained to predict channel properties associated with a particular environment (e.g., a specific area of an outdoor and/or indoor space), the reliability and/or accuracy of the ML model may vary as the environment changes over time, for example, due to construction and/or remodeling of object(s) or structure(s) in the environment. Moreover, a UE may move from the environment associated with the ML model to a different environment that is incompatible with (or unsupported by) the ML model. Accordingly, the capability of the ML model to provide accurate and/or reliable information related to wireless communications in the environment may depend on the state of the environment in which the UE is located.

Aspects described herein provide various schemes for lifecycle management (LCM) of an ML model trained and/or configured for perception-aided wireless communications. As discussed, a UE may use an ML model to predict a channel property associated with a communication channel based on perception information. In certain aspects, a UE may report, to a network entity, the performance associated with the ML model, and the network entity may monitor the reported performance associated with the ML model. The network entity may perform various actions (e.g., LCM task(s)) based on the reported performance associated with the ML model, as further described herein. In certain aspects, the UE may be configured with certain trigger state(s) that indicate when to report performance metric(s), when to send training data associated with the ML model, and/or when to activate and/or deactivate the ML model.

One aspect provides a method for wireless communications by an apparatus. The method includes obtaining a first configuration that indicates to predict at least one channel property, based at least in part on perception information, using a first machine learning (ML) model; communicating, via at least one communication channel, based at least in part on a prediction of one or more channel properties associated with the at least one communication channel, wherein the prediction of the one or more channel properties is obtained via the first ML model; and sending an indication of one or more performance metrics associated with predicting the one or more channel properties via the first ML model.

Another aspect provides a method for wireless communications by an apparatus. The method includes sending a first configuration that indicates to predict at least one channel property, based at least in part on perception information, using a first ML model; communicating with a user equipment, via at least one communication channel, based at least in part on a prediction of one or more channel properties associated with the at least one communication channel, wherein the prediction of the one or more channel properties is based on the first ML model; and obtaining an indication of one or more performance metrics associated with predicting the at least one channel property via the first ML model.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 illustrates example operations for radio resource control (RRC) connection establishment and beam management.

FIG. 9 depicts an example architecture for perception-aided wireless communications by a UE.

FIG. 10 depicts an example architecture of a machine learning model trained to predict a channel property associated with a transmit-receive beam pair.

FIG. 11 depicts examples of UE configurations associated with perception information and beamforming.

FIG. 12 illustrates an example architecture for training a machine learning (ML) model to determine a channel property associated with a beam based at least in part on perception information.

FIG. 13 depicts a process flow for an ML model training for perception-aided wireless communications.

FIG. 14 depicts a process flow for an ML model deployment for perception-aided wireless communications.

FIG. 15 depicts a process flow for lifecycle management of an ML model configured for perception-aided wireless communications.

FIG. 16 depicts a method for wireless communications.

FIG. 17 depicts another method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for perception-aided wireless communications. As used herein, extended reality (XR) may include virtual reality (VR), augmented reality (AR), and/or mixed reality (MR).

As radio signals travel from a transmitter to a receiver through a communication channel, the radio signals are subjected to certain signal propagation effects (e.g., Doppler effects, scattering, fading, interference, noise, etc.). As a result, the radio signals experience attenuations and phase shifts through the communication channel. Certain wireless communications systems (e.g., 5G New Radio (NR) systems and/or any future wireless communications system) rely on estimating channel properties based on measurements of reference signals communicated via the communication channel between the transmitter and receiver.

In some cases, closed-loop feedback associated with the communication channel may be used to dynamically adapt communication link parameters (e.g., modulation and coding scheme (MCS), beamforming, multiple-input and multiple-output (MIMO) layers, etc.) according to time varying channel conditions, for example, due to changes with respect to user equipment (UE) mobility, weather conditions, scattering, fading, interference, noise, etc. A UE may report channel state feedback (CSF) to a network entity (e.g., a base station), which may adjust certain communication parameters in response to the feedback from the UE. Link adaptation (such as adaptive modulation and coding) with various modulation schemes and channel coding rates may be applied to certain communication channels.

As an example, a UE receives a reference signal transmitted by a network entity, and the UE estimates the channel state based on measurements of that reference signal. The UE reports an estimated channel state to the network entity in the form of CSF, which may indicate channel properties of a communication link between the network entity and the UE. For example, the CSF may indicate the effect of, for example, scattering, fading, and path loss of a signal propagating across the communication link. A CSF report may include a channel quality indicator (CQI), a precoding matrix indicator (PMI), a layer indicator (LI), a rank indicator (RI), a reference signal received power (RSRP), a signal-to-interference plus noise ratio (SINR), etc. Channel measurements based on reference signals may be used for beam management (e.g., beam selection, beam failure detection, beam failure recovery, etc.) and/or radio link management (e.g., radio link failure detection and/or triggering handover scenarios).

Certain wireless communications devices (e.g., a UE in communication with (or integrated with) an XR device) may have access to perception information that provides an awareness of the physical environment in which the device is located. As used herein, perception information may refer to information that provides an understanding or awareness of an environment in which a device located. The perception information may indicate or include one or more characteristics of the environment in which the device is located, such as characteristics associated with the device and/or any other objects or devices in the environment. As an example, a device (e.g., an XR device) may be equipped with multiple sensors that can be used to form a perception of the environment, such as the position and/or orientation of the device (e.g., a UE), the position and/or size of object(s) or structures(s) (that may influence wireless communications with the device), the position of another wireless device (e.g., a base station), etc. In some cases, the device may be capable of capturing images of the environment, for example, for an AR application. Accordingly, the perception information may include the position of the device, the orientation of the device, and/or one or more images of the environment. Moreover, certain perception information may be generated by a device with a periodicity, such as pose information (e.g., position and/or orientation) being measured with a periodicity of 4 milliseconds, and thus, certain perception information can provide a highly reliable, low latency metric associated with the environment.

A UE may use the perception information to assist with communicating via a wireless communication channel. As certain perception information is generated periodically with a low latency, the UE may use the perception information for radio resource management operations, such as initial access with a network entity, beam selection, beam failure detection, beam failure recovery, etc. In some cases, the relationship between the perception information and a wireless communication channel may be characterized via artificial intelligence (AI), such as machine learning (ML). For example, an ML model may be trained to predict certain channel properties associated with a communication link given perception information as input to the ML model.

Technical problems for perception-aided wireless communications include, for example, enabling effective life cycle management of ML model(s) used for perception-aided wireless communications. As an ML model may be trained to predict channel properties associated with a particular environment (e.g., a specific area of an outdoor and/or indoor space), the reliability and/or accuracy of the ML model may vary as the environment changes over time, for example, due to construction and/or remodeling of object(s) in the environment. Moreover, a UE may move from the environment associated with the ML model to a different environment that is incompatible with (or unsupported by) the ML model. Accordingly, the capability of the ML model to provide accurate and/or reliable information related to wireless communications in the environment may depend on the state of the environment in which the UE is located.

Aspects described herein overcome the aforementioned technical problem(s) by providing various schemes for lifecycle management (LCM) of an ML model trained and/or configured for perception-aided wireless communications. As discussed, a UE may use an ML model to predict a channel property associated with a communication channel based on perception information. In certain aspects, a UE may report, to a network entity, the performance associated with the ML model trained and/or configured for perception-aided wireless communications, and the network entity may monitor the reported performance associated with the ML model. The network entity may perform various actions (e.g., LCM task(s)) based on the reported performance associated with the ML model, as further described herein. In some cases, the network entity may notify the UE to send training data associated with the ML model to the network entity to enable retraining of the ML model. In certain cases, the network entity may notify the UE to deactivate the ML model or switch to a different ML model. In certain aspects, the UE may be configured with certain trigger state(s) that indicate when to report performance metric(s) and/or training data associated with the ML model and/or that indicate when to activate and/or deactivate the ML model.

The techniques for perception-aided wireless communications described herein may provide various beneficial technical effects and/or advantages. The LCM schemes described herein may ensure that the output of the ML model is reliable and/or accurate for effective perception-aided wireless communications. The LCM schemes described herein may enable certain energy savings and/or improved performance of wireless communications (e.g., in terms of data rates, latency, and/or channel usage). As using the ML model to output predictions may consume a non-trivial amount of power, the LCM scheme(s) may ensure the ML model is used when the ML model satisfies certain criteria, for example, when the ML model is compatible with the environment that the ML model characterizes and/or when the ML model is providing accurate predictions. As the LCM scheme(s) may ensure the ML model is used when the ML model is providing accurate predictions, the ML model may provide channel property predictions that enable improved wireless communication performance, such as increased data rates, reduced latencies, and/or efficient channel usage.

In certain aspects, perception-aided wireless communications may enable energy savings and/or improved wireless communications performance. For example, a perception-based prediction of channel properties may enable a network entity to refrain from sending reference signal transmissions and/or increase the periodicity of such reference signal transmissions. Thus, the perception-based prediction of channel properties may allow the network entity and/or UE to reduce the power consumed in communicating reference signals and/or communicating any feedback associated with the reference signals. Moreover, the time-frequency resources allocated to the reference signals can be allocated to other traffic, such as data traffic and/or control signaling. Therefore, a perception-based prediction of channel properties can enable reduced channel usage for reference signal transmissions and/or any feedback associated with the reference signals. In addition, a perception-based prediction of channel properties may enable a UE and/or network entity to enhance channel estimations, and thus, the perception-based prediction of channel properties may enable increased data rates and/or reduced latencies for wireless communications.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

A “set” as discussed herein may include one or more elements.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

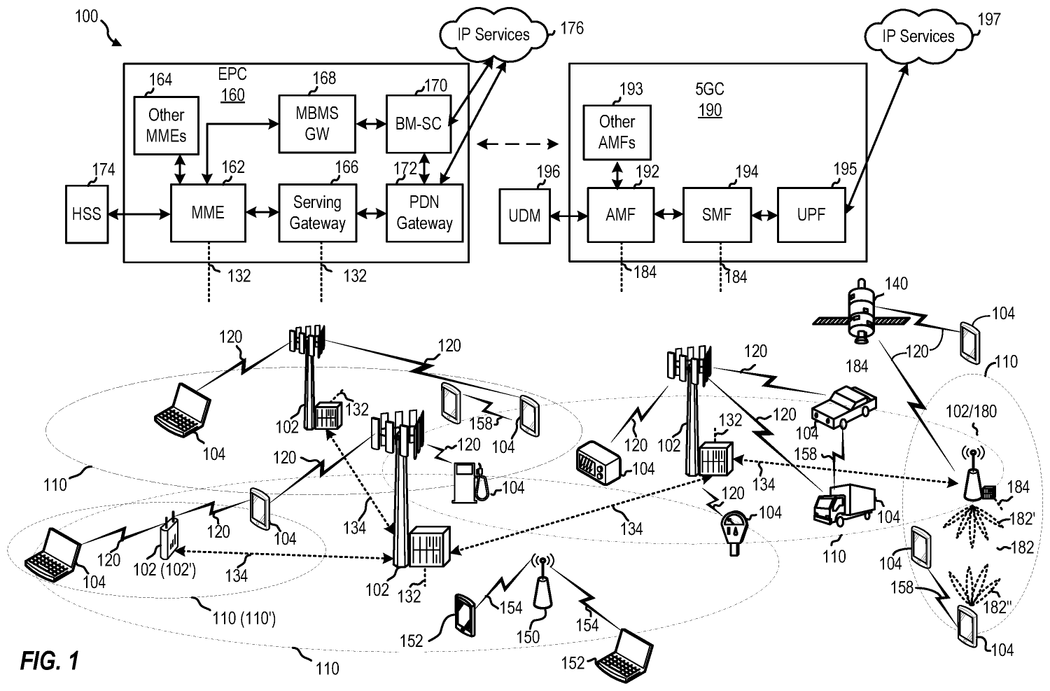

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

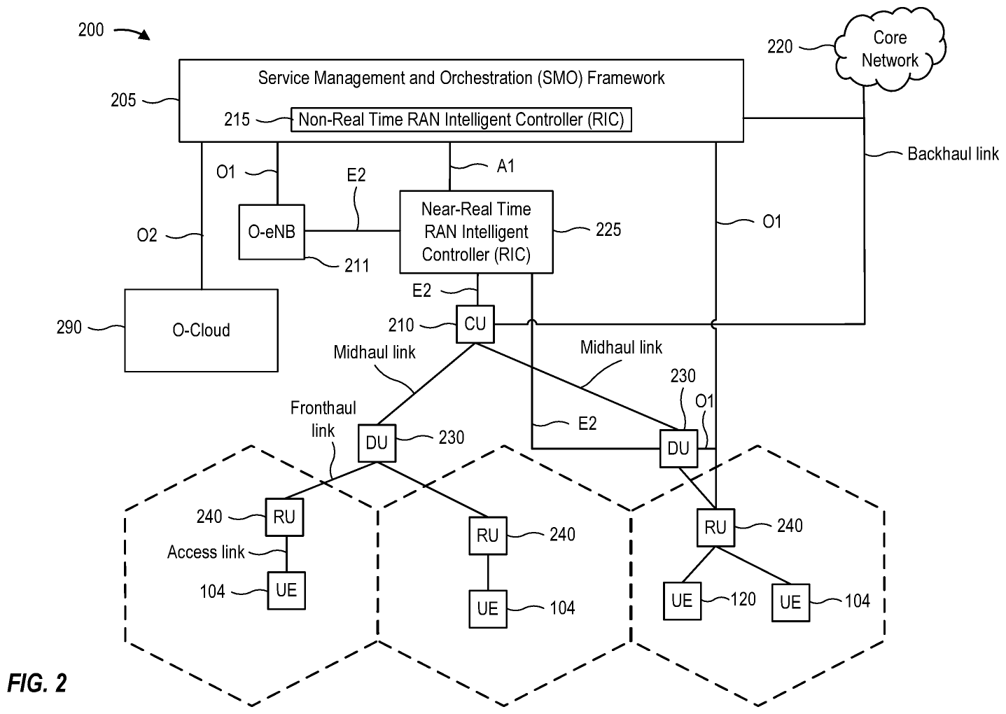

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

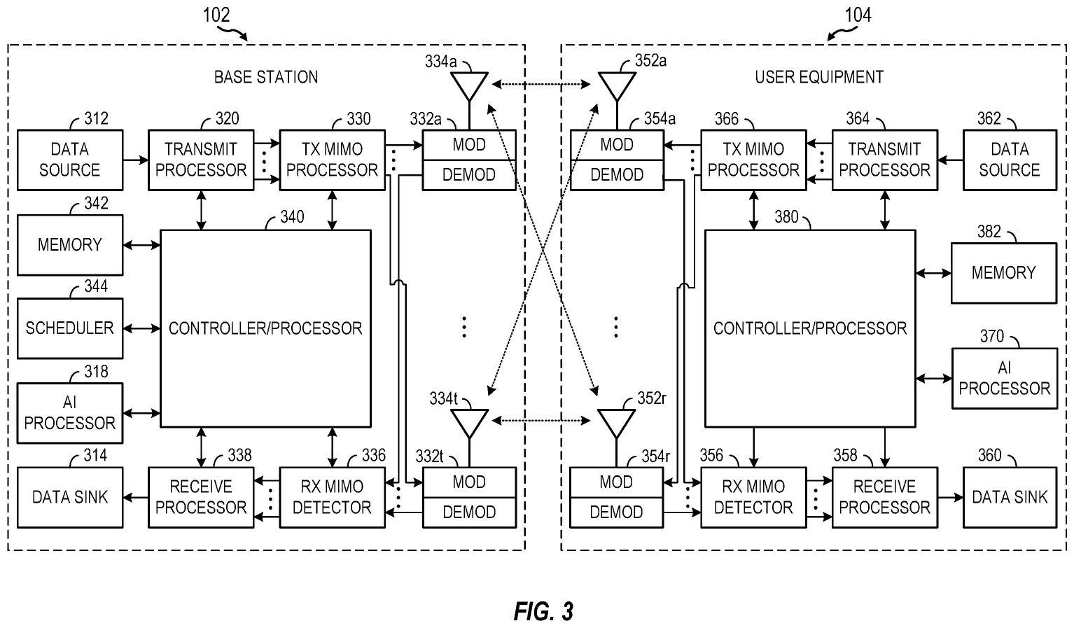

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

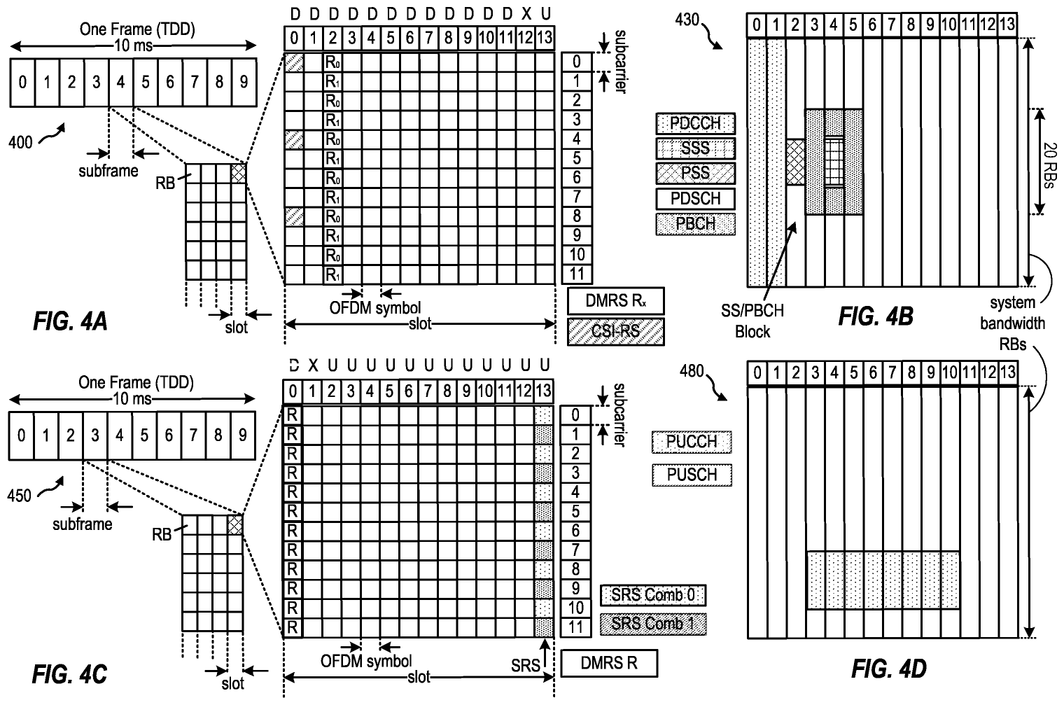

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

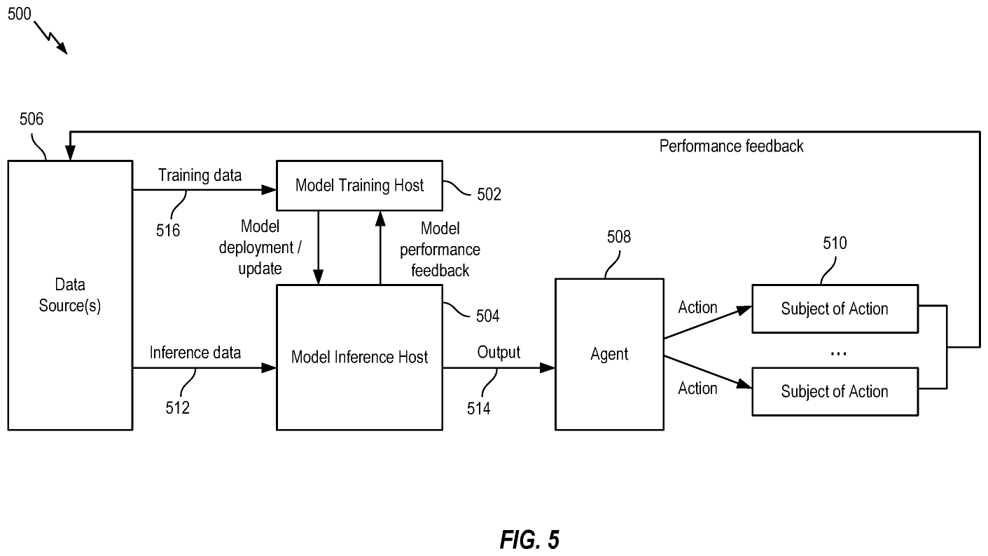

FIG. 5 is a diagram illustrating an example AI architecture 500 that may be used for AI-enhanced wireless communications, such as perception-aided prediction(s) as further described herein. As illustrated, the architecture 500 includes multiple logical entities, such as a model training host 502, a model inference host 504, data source(s) 506, and an agent 508. The AI architecture 500 may be used in any of various use cases for wireless communications described herein.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

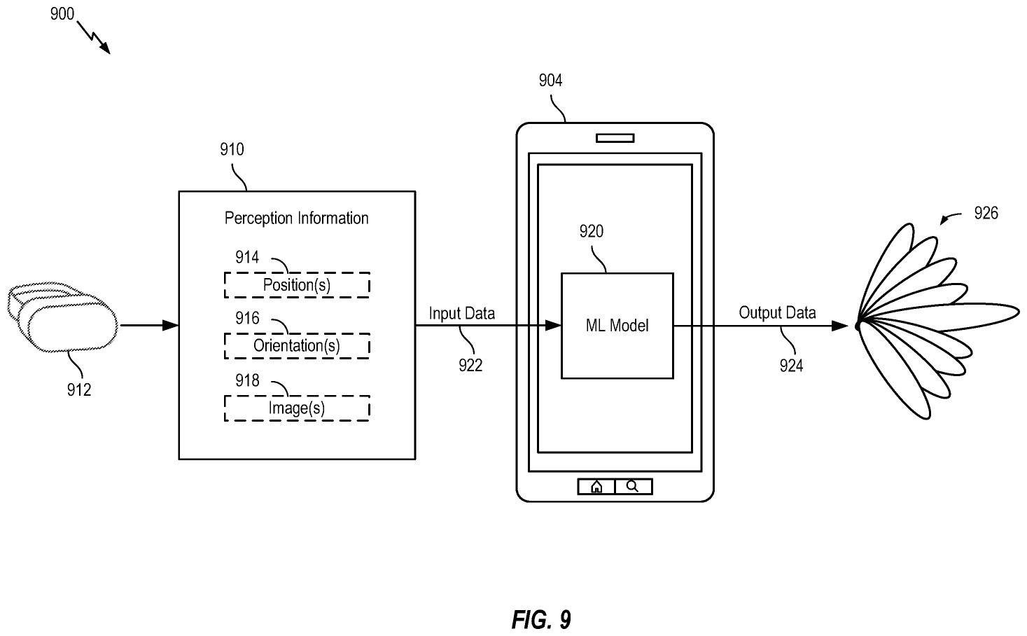

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, if the agent 508 may be a UE, the output 514 from model inference host 504 may be one or more predicted channel characteristics or properties for one or more beams. For example, the model inference host 504 may predict channel characteristics for a set of beams (or beam pairs) based at least in part on perception information as further described herein with respect to FIG. 9. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model may be deployed at or on a network entity for perception-aided wireless communications. More specifically, a model interference host, such as model inference host 504 in FIG. 5, may be deployed at or on the network entity for channel property predictions based at least in part on perception information, as further described herein.

In some aspects, an ML model may be deployed at or on a UE for perception-aided wireless communications. More specifically, a model inference host, such as model inference host 504 in FIG. 5, may be deployed at or on the UE for channel property predictions based at least in part on perception information, as further described herein.

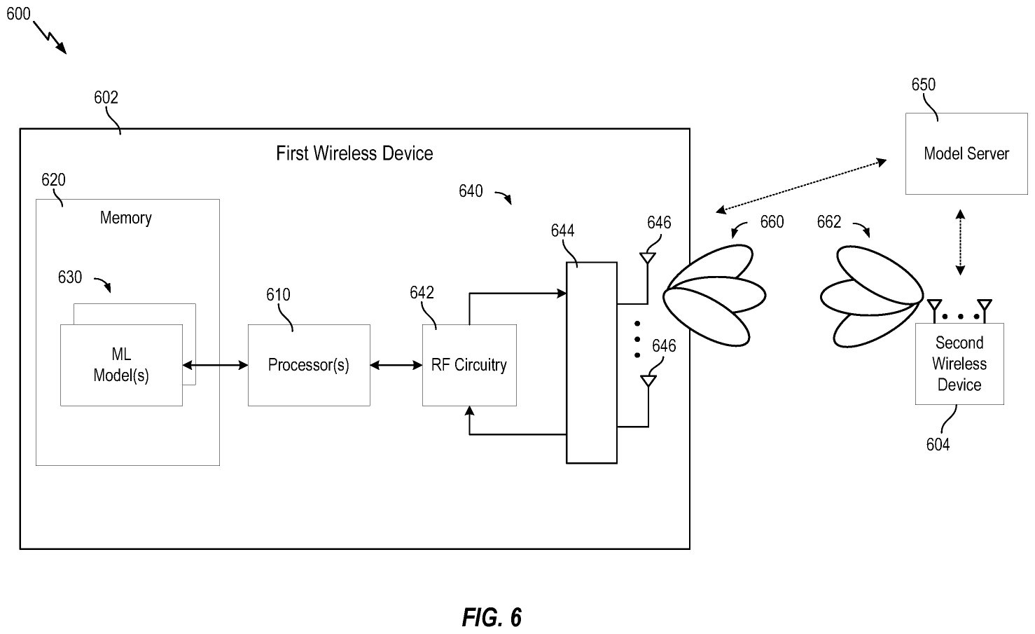

FIG. 6 illustrates an example AI architecture 600 of a first wireless device 602 that is in communication with a second wireless device 604. The first wireless device 602 may be a user equipment, for example, the UE 104 as described herein with respect to FIG. 1. Similarly, the second wireless device 604 may be a network entity, for example, the BS 102 or any disaggregated entity thereof as described herein with respect to FIGS. 1 and 2. Note that the AI architecture 600 of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may obtain at least perception information, as further described herein with respect FIG. 9, as input to predict a channel characteristic or channel property associated with one or more transmit-receive beam pairs used for communications between the first wireless device 602 and the second wireless device 604. The transmit-receive beam pair(s) may be formed from a first set of beams 660 associated with the first wireless device 602 and a second set of beams 662 associated with the second wireless device 604. The input data fed to the ML model 630 may include, for example, a position and/or orientation of the first wireless device 602. The output data provided by the ML model 630 may include, for example, one or more predicted measurements (or characteristics) associated with the one or more transmit-receive beam pairs, which may be formed via the sets of beams 660, 662. In certain aspects, transmit-receive beam pair(s) for which the one or more measurements are predicted may be considered “virtual beams” in they are not actually used for communications, but the measurements are predicted as though they were transmitted. In certain aspects, transmit-receive beam pair(s) for which the one or more measurements are predicted may actually be transmitted but not actually measured by first wireless device 602. Note that other input data and/or output data may be used in addition to or instead of the examples described herein.

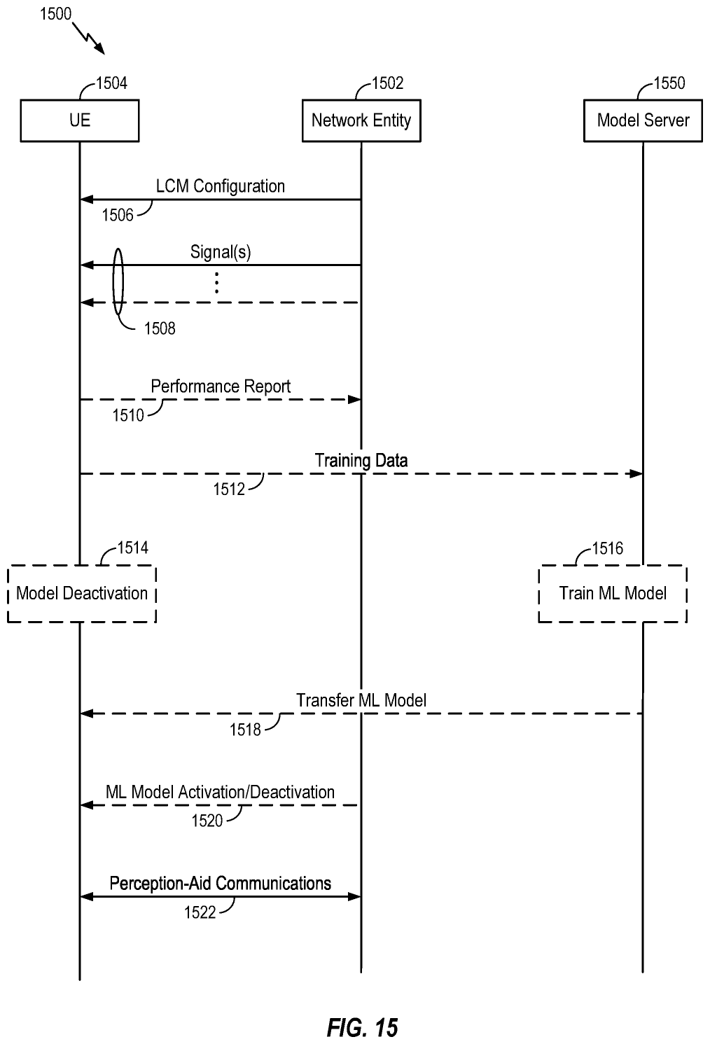

In certain aspects, a model server 650 may perform any of various ML model lifecycle management (LCM) tasks for the first wireless device 602 and/or the second wireless device 604, for example, as further described herein with respect to FIG. 15. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

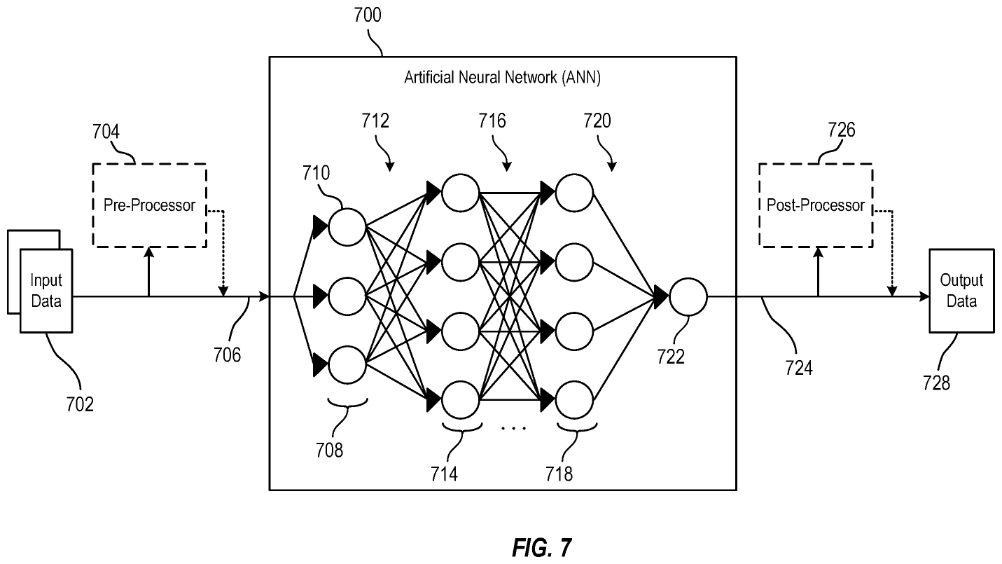

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Beam Management

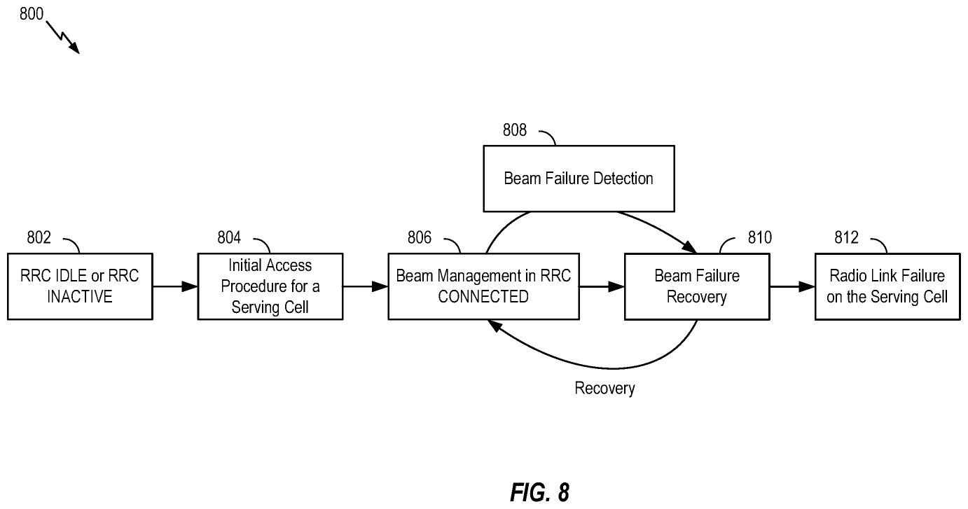

FIG. 8 illustrates example operations 800 for radio resource control (RRC) connection establishment and beam management. As shown, at block 802, a UE may initially be in an RRC idle state (or an RRC inactivate state). An RRC idle state refers to a state of a UE where the UE is switched on but does not have any established RRC connection (e.g., an assigned communication link) to a radio access network (RAN). Reference to a RAN may refer to one or more network entities (e.g., a base station and/or one or more disaggregated entities thereof). The RRC idle state allows the UE to reduce battery power consumption, for example, relative to an RRC connected state. For example, in the RRC idle state, the UE may periodically monitor for paging from the RAN. The UE may be in an RRC idle state when the UE does not have data to be transmitted or received. In an RRC connected state, the UE is connected to the RAN and radio resources are allocated to the UE. In some cases, the UE is actively communicating with the RAN when in the RRC connected state.

In order to perform data transfer and/or make/receive calls, the UE establishes a connection with the RAN using an initial access procedure, at block 804. For example, the UE establishes a connection to a particular serving cell of the RAN. The initial access procedure is a sequence of processes performed between the UE and the RAN to establish the RRC connection. For example, the UE may initiate a random access procedure that includes an RRC setup request or an RRC connection request. The UE may be in an RRC connected state subsequent to establishing the connection.

In some cases, the UE may perform beam management operations at block 806 in response to entering the RRC connected state. Beam management operations includes a set of operations used to determine certain receive beam(s) and/or transmit beams that can be used wireless communications (e.g., transmission and/or reception at the UE). The beam management may include certain P1, P2, and/or P3 beam management procedures, where P1 may involve initial beam selection, P2 may involve transmit beam refinement, and P3 may involve receive beam refinement.

Beam management procedures may further include beam failure detection operations at block 808 and beam failure recovery operations at block 810. For example, a UE may detect a beam failure when a layer 1 (L1) reference signal received power (RSRP) for a connected beam falls below a certain threshold (e.g., a threshold corresponding to a block error rate (BER)). In response to detecting beam failure at block 808, the UE identifies a candidate beam suitable for communication and performs beam failure recovery (BFR). For example, the UE may send, to the RAN, a request to switch to the candidate beam for communications. In some cases, the UE may send the beam switch request via a random access procedure using the candidate beam. The RAN may activate the candidate beam or a different beam at the UE. If the BFR is not successful, the UE may declare a radio link failure (RLF) for the serving cell, at block 812. In response to RLF, the UE may perform a cell reselection process to establish a communication link on a different serving cell.

### Aspects Related to Perception-Aided Wireless Communications

Aspects of the present disclosure provide certain schemes for lifecycle management (LCM) of an ML model trained and/or configured for perception-aided wireless communications. In certain aspects, a UE may be configured to perform certain LCM task(s) in response to one or more trigger states associated with predictions of an ML model, such as reporting the performance of the ML model, ML model deactivation, sending training data associated with the ML model, etc. The LCM schemes may ensure that the ML model is consistently providing channel property prediction(s) with a certain level of accuracy and/or reliability, e.g., even as environments change over time and/or as a UE transitions between different environments.

FIG. 9 depicts an example architecture 900 for perception-aided wireless communications by a UE 904. In certain aspects, the UE 904 may be an example of the UE 104 described herein with respect to FIGS. 1 and 3. The perception-aided wireless communications may enable the UE 904 to perform various radio resource management tasks using perception information 910, such as beam management (e.g., beam selection, beam failure detection, and/or beam failure recovery) and/or radio link management (e.g., serving cell or carrier management), as described herein with respect to FIG. 8. For example, the perception information 910 may enable the UE 904 to effectively perform virtual or simulated beam sweeps for beam selection and/or beam failure detection.

The UE 904 may have access to perception information 910, for example, generated by an XR device 912, which may be in communication with the UE 904 and/or integrated with the UE 904. Though an XR device 912 is discussed as providing perception information 910, it should be noted that any suitable device may provide perception information 910. For example, the UE 904 itself may generate perception information 910, such as using one or more sensors of UE 904. In some cases, the UE 904 may be or include an XR device equipped with a transceiver (such as the transceiver 640 of FIG. 6). In certain cases, the UE 904 may be tethered to the XR device 912, for example, via a data cable, or UE 904 may be in wireless communication with the XR device 912. In certain aspects, the XR device 912 may be or include XR glasses, an XR headset (e.g., a head mounted display (HMD)), XR glove(s), XR controller(s) (e.g., an XR input device), an XR base station, one or more sensors, and/or the like. An XR base station may be or include a controller that tracks one or more other XR device(s), such as an XR headset and/or hand-held controls. In certain aspects, the XR device 912 may be an example of any suitable device (e.g., a smart device) that generates perception information. As an example, a smart device (e.g., smart glasses, smart phone, or smart watch) may be equipped with one or more sensors that generate perception information, and the UE 904 may have access to such perception information of the smart device.

The perception information 910 may be generated by (and/or derived from measurements of) one or more sensors (not shown) of the XR device 912 and/or the UE 904. The sensors may include, for example, a camera, accelerometer, gyroscope, an inertial measurement unit (IMU), an optical sensor, an acoustic sensor or microphone, a proximity detector, a radar sensor, a lidar sensor, a sonar sensor, a barometer, a magnetometer, etc. In certain aspects, the perception information may be formed based on (or derived from) information (e.g., measurements) output by the sensor(s) of the XR device 912 and/or the UE 904. The perception information may characterize the environment in which the UE 904 is located, and in some cases, the environment may be or include one or more cell coverage areas associated with one or more network entities.

As an example, the perception information 910 may include position information 914, orientation information 916, and/or one or more images 918 of the environment in which the UE 904 is located. The position information 914 may be or include one or more positions of the UE 904 and/or the XR device 912, for example, with respect to a coordinate system; and the orientation information 916 may be or include one or more orientations of the UE 904 and/or the XR device 912, for example, with respect to a coordinate system. More specifically, the position information 914 may be or include one or more locations or positions of the UE 904 in a coordinate system (e.g., along an x-axis, y-axis, and/or z-axis). The orientation information 916 may be or include one or more degrees of rotation around the coordinate system (e.g., pitch, yaw, and/or roll with respect to the x-axis, y-axis, and/or z-axis, respectively). In certain cases, the perception information 910 may include a series of perception information over a time period. In some cases, the position information 914 may be or include one or more global positioning coordinates.

In certain aspects, the perception information 910 may include pose information (e.g., an XR pose) including the position information 914 and/or the orientation information 916 of the UE 904 and/or XR device 912. For XR applications, the pose information may be generated with a periodicity (e.g., every 4 milliseconds), and thus, pose information can provide a highly reliable, low latency metric for perception-aided wireless communications, such as radio resource management operations including beam management as described herein with respect to FIG. 8. In certain aspects, the perception information 910 may be defined in terms of three degrees of freedom (3DoF) (e.g., pitch, yaw, and/or roll), one or more translational movement parameters (e.g., up, down, left, right, forward, and/or backward), and/or six degrees of freedom (6DoF). Note that the parameters of the perception information 910 depicted in FIG. 9 are an example. Other information and/or properties that characterize the environment in which the UE 904 is located may be included as perception information in addition to or instead of the perception information depicted in FIG. 9.

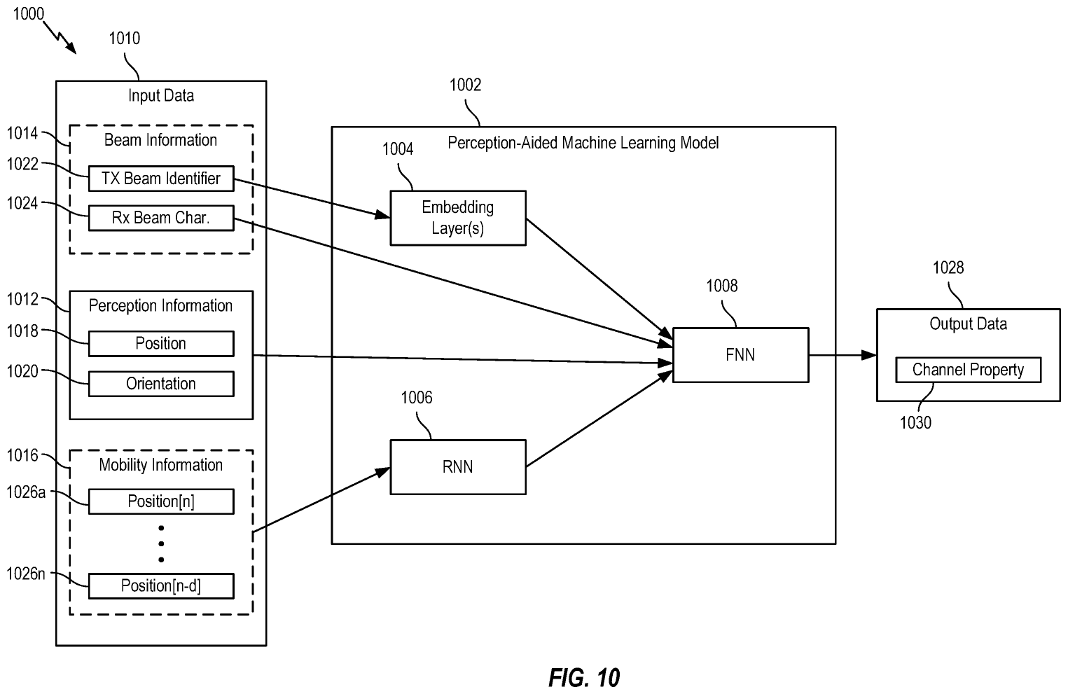

In the example depicted in FIG. 9, a trained ML model 920 is deployed at or on the UE 904 to enable perception-aided wireless communications, and more specifically, channel property predictions, based at least in part on input data 922 associated with the perception information 910. The UE 904 may obtain the perception information 910, for example, via one or more sensors of the XR device 912 and/or one or more sensors of the UE 904. The UE 904 feeds input data 922, which includes the perception information 910, to the ML model 920. As further described herein with respect to FIG. 10, the input data 922 may include other information, such as beam information including an indication of one or more transmit-receive beam pairs for which the prediction(s) are made and/or the like.

The ML model 920 may be trained to transform the perception information 910 into one or more channel property predictions. The ML model 920 may be trained to generate one or more channel property predictions based at least in part on the perception information 910. As certain environments may have predictable signal propagation effects depending on the position and/or orientation of the UE 904 relative to a network entity in an environment (e.g., a coverage area of the network entity), the ML model 920 may be trained to effectively learn the channel conditions that can be encountered at a specific location and/or orientation of the UE 904 for various transmit-receive beam pairs, for example, between the UE 904 and a network entity. As an example, certain areas in the environment may have certain static interference causing objects (e.g., that emit signals, block signals, etc.), such that the channel conditions may be predictable based on the position of the UE 904 in the environment. As another example, various objects or structures may be arranged in the environment (e.g., tree(s), building(s), wall(s), furniture, vehicle(s), etc.), and the ML model 920 may be trained to effectively learn the signal propagation effects caused by the object or structure in the environment depending on the location and/or orientation of the UE 904.

The ML model 920 provides output data 924, for example, including one or more predictions. More specifically, the ML model 920 may provide one or more predicted (e.g., simulated or virtual) measurement values 926 for a set of communication resources (e.g., time-frequency resource(s)) associated with a set of beams including transmit beam(s) and/or receive beam(s). The one or more measurement values 926 may include a predicted channel characteristic and/or property (e.g., a predicted Layer-1 (L1) RSRP measurement value) associated with the set of communication resources, where the set of communication resources are associated with the set of beams. The measurement value and/or channel property may include, for example, a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). In certain aspects, the measurement values 926 may be associated with a communication channel corresponding to a particular transmit-receive beam pair.

Accordingly, the UE 904 may perform perception-aided channel property prediction using the ML model 920. As an example, the UE may perform a simulated beam sweep using the ML model 920 trained to predict a channel property (e.g., RSRP) associated with a communication channel (e.g., a transmit-receive beam pair) given at least the perception information 910. The UE 904 may obtain predicted channel properties associated with multiple beams via the ML model 920, and the UE 904 may use the predicted channel properties associated with the beams to select a beam for wireless communications. The UE 904 may select a beam for wireless communications that is predicted to provide the strongest signal strength or signal quality among the predicted channel properties. The UE 904 may use the predicted channel properties based on the perception information for beam management (e.g., beam selection, beam failure detection, beam failure recovery, cell selection, etc.).

In certain aspects, the output data 924 may be generated without measurements of reference signals, for example, output or transmitted by a network entity. The perception-aided wireless communications described herein can enable reduced reference signal transmissions and/or feedback associated with such reference signals transmission. Thus, the perception-aided wireless communications described herein can enable increased channel capacity for other traffic as the communication resources used for reference signals and/or feedback can be allocated for other communications.

### Example Machine Learning Model for Perception-Aided Wireless Communications

FIG. 10 depicts an example architecture 1000 of an ML model 1002 trained and/or configured to predict a channel property associated with a specific transmit-receive beam pair (e.g., a beam pair link). The ML model 1002 may be trained and/or configured to provide predictions for a set of transmit beams used for communications by or at one or more network entities. The ML model 1002 may be an example of an ANN, such as the ANN 700 of FIG. 7. More specifically, the ML model 1002 may include one or more embedding layers 1004 (hereinafter “the embedding layers 1004”), a recursive neural network (RNN) 1006, and a fully connected neural network (FNN) 1008.

The ML model 1002 obtains input data 1010, which includes at least perception information 1012. The input data 1010 may be fed to the embedding layers 1004, RNN 1006, and/or the FNN 1008. The input data 1010 may further include beam information 1014 and/or mobility information 1016 associated with a UE (e.g., the UE 104, 904). The perception information 1012 may include pose information associated with an XR device (such as the XR device 912) and/or the UE. More specifically, the perception information 1012 may include a position 1018 of the UE and/or an orientation 1020 of the UE.

The beam information 1014 may include one or more beamforming characteristics associated with a communication channel formed via transmit beam and receive beam pair, for example, as discussed herein with respect to FIG. 6. The beam information 1014 may be or indicate a query transmit-receive beam pair to which the output data of the ML model 1002 corresponds or belongs. As an example, the beam information 1014 may include one or more transmit beam identifiers 1022 and/or receive beam characteristic(s) 1024, such as a beam vector indicative of an AoD and/or AoA associated with a receive beam. The transmit beam identifier 1022 may be or include a value that identifies a specific transmit beam, for example, used by or at a network entity for transmission. The receive beam characteristic(s) 1024 may include a UE receive beam vector having a magnitude and direction given by the beam shape, for example, the beam gain and direction relative to a local coordinate system (e.g., XR system reference point) and/or a global coordinate system as further described herein. In some cases, the receive beam characteristic(s) 1024 may include any of the properties or parameters associated with an antenna (or radiation) pattern discussed herein with respect to a beam. Accordingly, the beam information 1014 may include information that characterizes the beamforming of a communication channel between a transmit beam and receive beam formed between wireless communication devices (e.g., a UE and network entity).

In certain aspects, at least a portion of the beam information (e.g., the transmit beam identifier 1022) is fed to the embedding layers 1004, which may determine one or more transmit beam characteristics (e.g., transmit beam shape attributes) associated with the transmit beam of the transmit beam identifier. The output of the embedding layers 1004 is fed to the FNN 1008. In certain aspects, the receive beam characteristics 1024 may be fed to the FNN 1008.

The mobility information 1016 may indicate the movement or mobility of the UE over time. The mobility information 1016 may be or include one or more past and/or future positions of a UE. As an example, the mobility information 1016 may include the past d positions 1026a-n of the UE over a time period. The mobility information 1016 may allow the ML model 1002 to determine the velocity of the UE, the acceleration of the UE, and/or an estimated trajectory of the UE. In certain aspects, the mobility information 1016 is fed to the RNN 1006, which may determine the velocity of the UE, the acceleration of the UE, and/or an estimated trajectory of the UE. The output of the RNN 1006 is fed to the FNN 1008. In certain aspects, the velocity of the UE, the acceleration of the UE, and/or an estimated trajectory of the UE may be obtained from (or determined based on measurements or information output by) one or more sensors (e.g., an IMU and/or global positioning system) without the RNN 1006, and such information may be fed to the ML model 1002 and/or the FNN 1008.

The embedding layers 1004 may include an input layer and/or one or more hidden layers of the ML model 1002. The RNN 1006 may include an input layer and/or one or more hidden layers of the ML model 1002. The FNN 1008 may include an input layer, one or more hidden layers, and/or an output layer of the ML model 1002. The embedding layers 1004 may be arranged in a pipeline with the FNN 1008, and the RNN 1006 may be arranged in another pipeline with the FNN 1008. The FNN may process the input from the embedding layers 1004 and the RNN 1006 as well as the perception information 1012 to predict a channel property associated with a communication channel, such as transmit-receive beam pair indicated in the beam information.

The ML model 1002 provides output data 1028 that includes at least a predicted value of a channel property associated with a transmit-receive beam pair (e.g., a communication channel or link between a transmit beam and receive beam). As discussed herein, the channel property may be or include a CQI, SNR, SINR, SNDR, RSSI, RSRP, a RSRQ, and/or BLER.

Certain parameter(s) of the input data 1010 may be fed to the ML model 1002 in terms of a global or common coordinate system shared between the UE and one or more network entities. For example, the perception information, the receive beam characteristic(s), and/or the mobility information may be provided to the ML model 1002 in terms of the global coordinate system.

Note that the ML model 1002 of FIG. 10 is an example ML architecture to facilitate an understanding of ML techniques for perception-aided wireless communications, and more specifically, perception-aided channel property predictions. In certain aspects, an ML model may be trained and/or configured to output a prediction of a channel property for a specific transmit-receive beam pair without the beam information and/or mobility information. For example, the ML model may effectively perform a virtual (or simulated) beam sweep and output a prediction for the transmit-receive beam pair that provides the strongest channel conditions among the conditions for multiple transmit-receive beam pairs.

### Example UE Architectures for Perception-Aided Wireless Communications

The perception information of a UE (e.g., an XR device) may be defined with respect to a local coordinate system specific to the UE (and/or type of UE). The UE may be configured to translate the perception information into a global or common coordinate system that accounts for the position of a network entity in communication with the UE. The global or common coordinate system may enable determination of the position of the UE with respect to the position of the network entity.

In certain aspects, the UE and/or network entity may determine one or more parameters (or functions) that can translate the local coordinate system of the UE to a global coordinate system. The position of the UE may be converted from a local coordinate system to a global coordinate system using the following expression:

$${t}_{wld} [ n ] = {A}_{wld} {t}_{6 dof} [ n ] + {b}_{wld} \qquad ( 1 )$$

where t_{wid}[n] is the position vector of the UE at time instance n in the global coordinate system; t_{6dof}[n] is the position vector of the UE at time instance n relative to a local coordinate system, for example, with respect to a reference point or origin of an XR coordinate system (e.g., as defined by an XR software development kit, an XR engine, or 6DoF engine), which may be UE-specific; A_{wid} is a rotation matrix for the local coordinate system-to-global coordinate system conversion; and b_{wld} is a translation vector for the local coordinate system-to-global coordinate system conversion. In certain aspects, the rotation matrix and/or translation vector may be determined using images (e.g., the image(s) 918) captured from or at the UE based on visual positioning system (VPS) technique(s).

The orientation of the UE may be converted from a local coordinate system to a global coordinate system using the following expression:

$${R}_{wld} [ n ] = {A}_{wld} {R}_{6 dof} [ n ] \qquad ( 2 )$$

where R_{wld}[n] is the orientation matrix (e.g., pitch, yaw, and/or roll) of the UE at time instance n relative to the global coordinate system; R_{6dof}[n] is the orientation matrix of the UE at time instance n relative to the local coordinate system, which may be UE-specific; and A_{wid} is a rotation matrix for the local coordinate system-to-global coordinate system conversion.

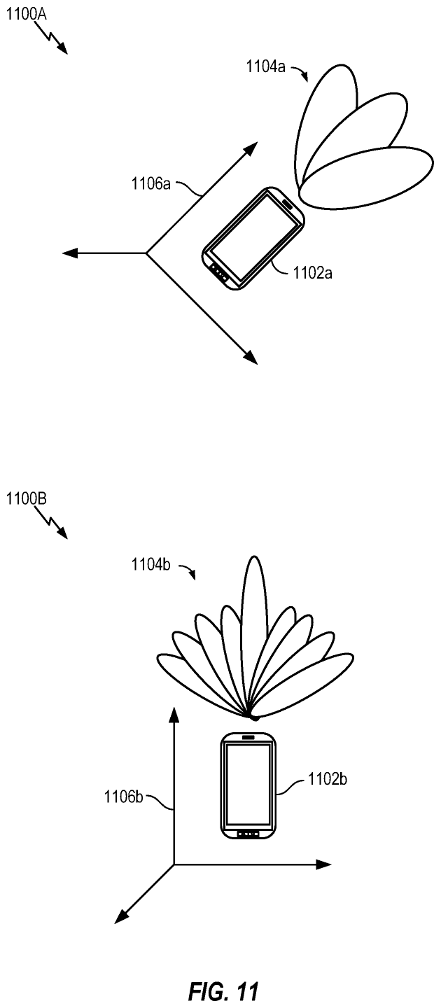

FIG. 11 depicts examples of UE configurations 1100A, 1100B associated with perception information and beamforming. Each of the UE configurations 1100A, 1100B may be or include a specific type of UE configuration with different capabilities for beamforming and/or perception information associated with a particular UE. The first UE configuration 1100A may be associated with a first UE 1102a (or a first type of UE) equipped with an antenna architecture that forms a first set of beams 1104a. The first UE configuration 1100A may generate perception information (e.g., pose information) in a first local coordinate system 1106a, which may be specific to the first UE 1102a and/or an XR device (or smart device or sensor system) associated with the first UE 1102a.

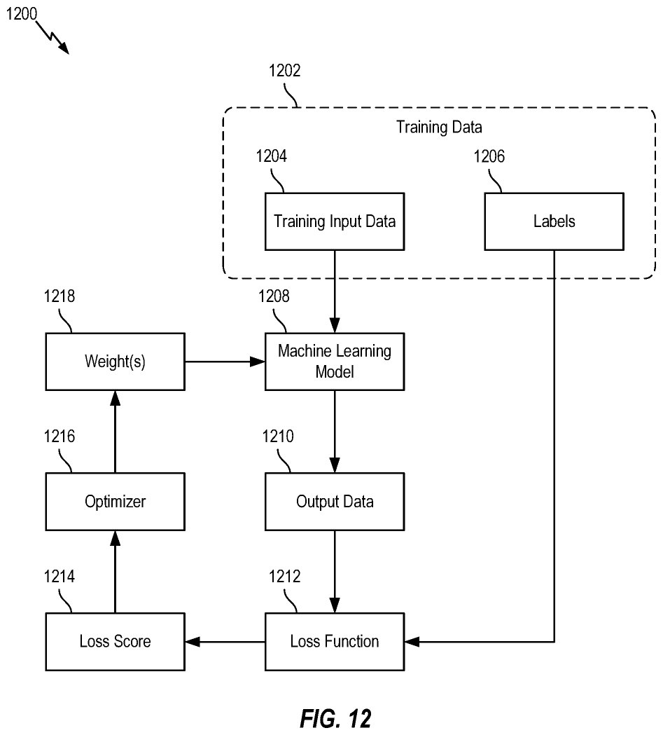

In this example, the second UE configuration 1100B may be associated with a second UE 1102b (or a second type of UE) equipped with an antenna architecture that forms a second set of beams 1104b that are narrower compared to the first set of beams 1104a. Thus, there may be more beams formed in the second set of beams 1104b than the first set of beams 1104a. The second UE configuration 1100B may generate perception information in a second local coordinate system 1106b, which is different from the first local coordinate system 1106a of the first UE configuration 1100A. For example, the first local coordinate system 1006a may define positions relative to a first reference point (e.g., the origin where the x-axis, y-axis, and/or z-axis intersect), and the second local coordinate system 1006b may define positions relative to a second reference point located at a different position than the first reference point associated with the first local coordinate system 1006a. In some cases, the axes of the local coordinate systems 1006a, 1006b may be rotated at different angles with respect to each other, for example, as depicted. Due to the different coordinate systems and/or beamforming capabilities, an ML model may be trained to predict channel properties associated with one or more UE configurations, such as the first UE configuration and/or the second UE configuration, as further described herein with respect to FIG. 12.

Note that the examples depicted in FIGS. 9 and 10 are described herein with respect to an ML model being deployed at or on a UE to facilitate an understanding of perception-aided wireless communications. Aspects of the present disclosure may also be applied to any suitable wireless communications device (e.g., a network entity) using an ML model to predict channel properties associated with a communication channel based on perception information. For example, in an augmented reality (AR) context, a UE may send certain perception information (e.g., pose information and/or image(s)) to a network entity (e.g., an AR edge application) for cloud-based AR processing, and the network entity may use the perception information to determine a beam for communicating between the UE and the network entity, e.g., based on feeding the received perception information to a trained ML model as discussed herein.

### Aspects of Training a Machine Learning Model for Perception-Aided Wireless Communications

FIG. 12 illustrates an example architecture 1200 for training an ML model to determine a channel property associated with a beam pair based at least in part on perception information. The architecture 1200 may be implemented by a model training host (e.g., the model training host 502 of FIG. 5). In some cases, the model training host may be or include any of the processors described herein with respect to FIG. 3 and/or FIG. 6. In certain aspects, the model training host may be or include the model server 650 of FIG. 6, which may collect training data from one or more wireless communications devices (e.g., the UE 104 and/or the first wireless device 602).

In this example, the model training host obtains training data 1202 including training input data 1204 and, optionally, corresponding labels 1206 for the training input data 1204. The training input data 1204 may include samples of perception information (e.g., samples of pose information generated by an XR device as discussed herein). A sample of perception information may be or include an instance of perception information measured and/or collected at a particular time. In some cases, the samples of perception information may include a time series of perception information, such as pose information of an XR device measured over time. In certain aspects, the training input data 1204 may include beam information and/or mobility information, for example, as described herein with respect to FIG. 10. The training input data 1204 may be simulated (e.g., computer generated) and/or collected from actual operations of a device (e.g., one or more sensors, XR device, smart device, and/or a UE), for example, under various simulated or actual operating conditions as further discussed herein.

The model training host may use the labels 1206 to evaluate the performance of the ML model 1208 and adjust the ML model 1208 (e.g., weights of the ANN 700 and/or the ML model 1002 of FIG. 10) as described herein. Each of the labels 1206 may be associated with at least one instance of perception information of the training input data 1204, such as a particular pose associated with a UE. In certain cases, each of the labels 1206 may include an expected or measured value of a channel property for a specific communication link (e.g., a transmit-receive beam pair). As an example, a UE may perform a beam sweep across multiple transmit-receive beam pairs and measure a channel property (e.g., RSRP) for each transmit-receive beam pair among the multiple beam pairs corresponding to one or more samples of perception information. Each of the labels 1206 may be measured at a UE for various transmit-receive beam pairs, under various operating conditions corresponding to one or more samples of perception information. In certain aspects, the labels 1206 may be simulated (e.g., computer generated) and/or measured at a device (e.g., a UE), for example, under various simulated or actual operating conditions corresponding to one or more samples of perception information. Thus, a set of labeled training data can be generated by a UE.

The model training host provides the training input data 1204 to an ML model 1208. In certain aspects, the ML model 1208 may include a neural network. The ML model 1208 may be an example of the ML model(s) described herein with respect to FIGS. 9 and 10. The ML model 1208 provides output data 1210, which may include an indication (e.g., a prediction) of a channel property associated with a communication link (e.g., a specific transmit-receive beam pair).

The model training host may evaluate the performance of the ML model 1208 and determine whether to update the ML model 1208, for example, based on the accuracy of the predicted channel property. The model training host may evaluate the quality and/or accuracy of the output data 1210. In some cases, the model training host may determine whether the output data 1210 matches the corresponding label 1206 of the training input data 1204. For example, the model training host may determine whether the predicted value of the channel property output by the ML model 1208 matches the expected or measured value of the channel property of the corresponding label 1206.

In certain aspects, the model training host may evaluate the performance of the ML model 1208 using a cost or loss function 1212 (hereinafter “the loss function 1212”). The loss function 1212 may be or include a comparison between the value of the channel property corresponding to the label 1206 (e.g., an expected or measured value) and the predicted value of the channel property output by the ML model 1208. In certain aspects, the loss function 1212 may be or include a difference between the value of the channel property corresponding to the label 1206 and the predicted value of the channel property output by the ML model 1208, for example, as a mean squared error or suitable similarity measure. The loss function 1212 may provide a loss value or score 1214 (hereinafter “the loss score 1214”) based on the comparison of the output data 1210 and the label 1206.

In certain aspects, the ML model 1208 may be trained in a supervised fashion where learnable parameters of the ML model are updated based on the loss score, for example, between the predicted value of the channel property and the corresponding label. In certain aspects, the ML model 1208 may be trained using a weighted or scaled loss score. As certain labels (e.g., a ground truth of a low signal strength or quality) may be affected by certain signal propagation effects (e.g., noise and/or interference), a larger weight or scaling factor may be applied to channel properties indicative of strong signal strength and/or quality for a communication link. For example, the loss score for a label having a high value for a signal strength may be increased by the weight or scaling factor, whereas the loss score for a different label having a low value for the signal strength may be decreased by the weight. In some cases, the weight may be increased for low values of the channel property, and the weight may be decreased for high values of the channel property. Accordingly, the weighted loss score may allow the ML model training to be focused at predicting accurate channel properties for certain communication links, for example, communication links with strong signal qualities and/or strengths.

A weighted loss score for RSRP predictions may be determined according to the following expression:

$$loss = w [ n ] {\vert RSRP [ n ] - [ n ] \vert}^{2} \qquad ( 3 )$$

where RSRP[n] is the RSRP of the ground truth or label, and [symbol] [n] is the predicted RSRP output by the ML model. w[n] is the weight applied to a particular loss score. The weight may be determined based on a maximum RSRP in a batch of training input data, for example, according to the following expression:

$$w [ n ] = RSRP [ n ] / {max}_{n} ( RSRP [ n ] ) \qquad ( 4 )$$

where

$${max}_{n} ( RSRP [ n ] )$$

the maximum RSRP of a set of RSRPs associated with the batch of training input data. As an example, the batch of training input data may be a subset of the training input data for which a weight is determined. Note the using maximum value of a channel property to determine the weight is an example. Other suitable metrics may be applied to determine the weight such as a minimum value, average value, and/or a median value.

The model training host may provide the loss score 1214 to an optimizer 1216, which may determine one or more updated weights 1218 (and/or model parameter(s)) for the ML model 1208. The optimizer 1216 may adjust the ML model 1208 (e.g., any of the weights and/or activations in a layer of a neural network) to reduce the loss score 1214 associated with the ML model 1208. In certain aspects, the optimizer 1216 may perform backpropagation or a suitable training algorithm to determine the updated weights 1218. In some cases, the model training host may continue to provide the training input data 1204 to the ML model 1208 and adjust the ML model 1208 using the weights 1218 until the loss score 1214 of the ML model 1208 satisfies a threshold and/or reaches a minimum value. The model training host may perform online training of the ML model 1208 or train the ML model 1208 using one or more batches of training data 1202. In certain aspects, the optimizer 1216 may be or include a root mean square propagation (RMSprop) optimizer, a descent gradient optimizer (e.g., a stochastic descent gradient (SGD)), a momentum optimizer, an Adam optimizer, etc. to minimize the loss score 1214 associated with perception-aided wireless communications.

In certain aspects, the model training host may train multiple ML models to perform perception-aided wireless communications, more specifically, perception-aided channel property predictions. The ML models may be trained or configured with different model performance characteristics, different operating environments (e.g., different UE configurations, different beam pairs, and/or different coverage areas), and/or different input-output schemes (e.g., different input data and/or different output data).

In some cases, the ML models may be trained to predict a channel property with different levels of accuracy (e.g., accuracies of 70%, 80%, or 99%) of meeting ground truth and/or different latencies (e.g., the processing time to predict the channel property). For example, a first ML model may be trained to predict channel properties with a low accuracy and latencies, whereas a second ML model may be trained to predict channel properties with high accuracy and latencies.

In certain cases, the ML models may be trained to provide channel property predictions for one or more types of UE configurations, for example, as described herein with respect to FIG. 11. As an example, a first ML model may be trained to provide channel property predictions for the first UE configuration 1100A of FIG. 11, whereas a second ML model may be trained to provide channel property predictions for the second UE configuration 1100B of FIG. 11. In certain aspects, an ML model may be trained to provide channel property predictions for multiple UE configurations, such as the first UE configuration and the second UE configuration.

In certain cases, the ML models may be trained to provide channel property predictions for one or more environments, such as one or more coverage areas of one or more network entities. For example, a first ML model may be trained to provide channel property predictions for a first coverage area of a first network entity, whereas a second ML model may be trained to provide channel property predictions for a second coverage area of a second network entity.

In certain cases, the ML models may be trained to provide channel property predictions for different input-output schemes. For example, a first ML model may be trained to provide channel property predictions based on input data that includes transmit-receive beam information, perception information, and mobility information; whereas a second ML model may be trained to provide channel property predictions based on input data that includes perception information. Thus, a UE and/or network entity may select the ML model that is capable of predicting channel properties in accordance with certain performance characteristics, operating environments, and/or input-output schemes as described above.

Note that the training architecture 1200 is an example of deep learning, and any suitable training architecture may be used in addition to or instead of the training architecture 1200 to train the ML model 1208.

### Example Signaling Related to ML Model Training for Perception-Aided Wireless Communications

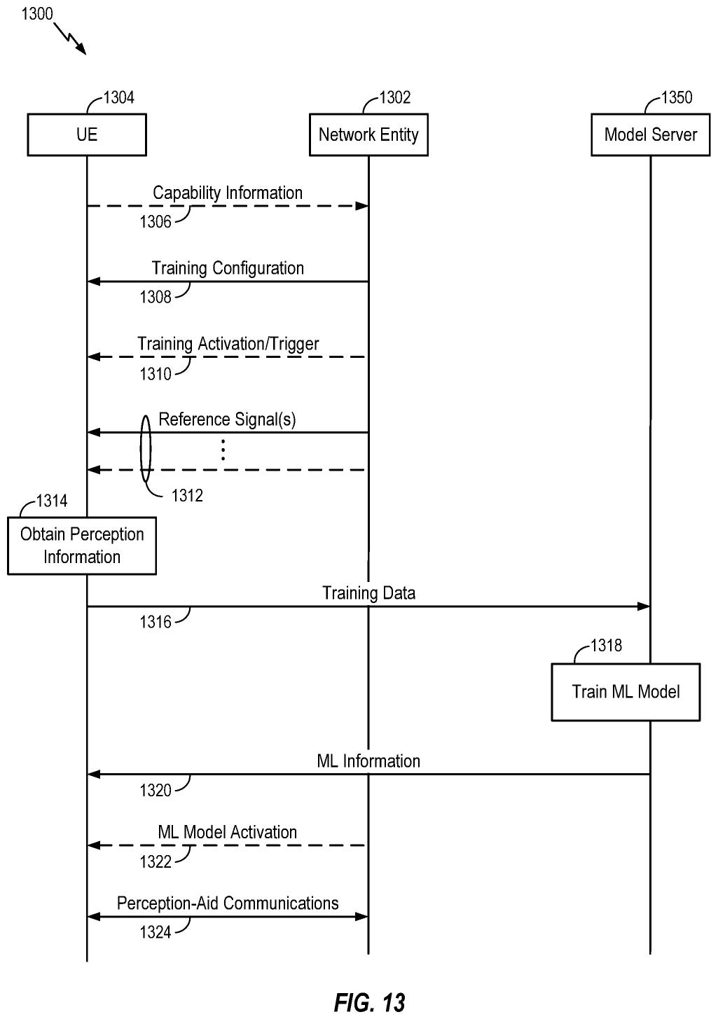

FIG. 13 depicts a process flow 1300 for ML model training for perception-aided wireless communications in a network between a network entity 1302, a user equipment (UE) 1304, and a model server 1350. In some aspects, the network entity 1302 may be an example of the BS 102 depicted and described with respect to FIGS. 1 and 3 or a disaggregated base station depicted and described with respect to FIG. 2. Similarly, the UE 1304 may be an example of UE 104 depicted and described with respect to FIGS. 1 and 3. However, in other aspects, UE 1304 may be another type of wireless communications device, and network entity 1302 may be another type of network entity or network node, such as those described herein.

In certain aspects, the model server 1350 may be in communication with the UE 1304 via the network entity 1302. In certain aspects, the model server 1350 may be integrated with the network entity 1302 and/or an example of a disaggregated entity of a base station. The model server 1350 may be implemented in or via a disaggregated base station (e.g., a CU and/or DU), core network (e.g., the 5GC network 190 and/or any other future core network), a cloud-based RAN (e.g., an open or virtual RAN architecture including a Near-RT RIC, a non-RT RIC, and/or an SMO framework), an application server in communication with a RAN, etc. Note that any operations or signaling illustrated with dashed lines may indicate that that operation or signaling is an optional or alternative example.

At 1306, the UE 1304 sends, to the network entity 1302, capability information that indicates a capability of the UE associated with perception-aided wireless communications. The capability information may indicate that the UE is capable of performing perception-aided wireless communications. The capability information may indicate the types of sensor(s) that the UE has to generate (and/or has access to obtain) perception information (e.g., camera(s), IMU, etc.) and/or the type of perception information that can be generated from such sensor(s) (e.g., position, orientation, and/or image(s)). In certain aspects, the capability information may indicate the local coordinate system (e.g., associated with an XR device) in which the perception information or other parameters are defined. In certain aspects, the capability information may indicate the arrangement of an RF transceiver and an XR device (e.g., a 6DoF engine) of the UE 1304, such as indicating that the RF transceiver and the XR device of the UE 1304 are co-located with each other or indicating a displacement (e.g., 10 centimeters) between the RF transceiver and the 6DoF engine. The transmit/receive beam vectors for the UE 1304 may depend on the displacement between the RF transceiver and the 6DoF engine.

At 1308, the UE 1304 obtains, from the network entity 1302, a training configuration that indicates certain training data to collect and transfer to the model server 1350. For example, the training configuration may indicate to collect one or more channel property measurements associated with transmit-receive beam pairs along with corresponding perception information. The training configuration may indicate to collect and/or transfer the training data on a periodic basis, a semi-persistent basis, and/or an aperiodic basis. The training configuration may be communicated via radio resource control (RRC) signaling, medium access control (MAC) signaling, downlink control information (DCI), system information and/or any suitable signaling. The training configuration may depend on the capability information communicated at 1306. For example, the network entity 1302 may generate a UE-specific training configuration based at least in part on the capability information communicated by the UE 1304 at 1306.

At 1310, the UE 1304 obtains, from the network entity 1302, an indication to activate the training configuration and/or to trigger the collection and transfer of training data to the model server 1350. The activation indication and/or the trigger may be communicated via MAC signaling and/or DCI. As an example, an activation indication may activate the UE 1304 to obtain channel property measurements and perception information periodically on a semi-persistent basis. Such an indication to activate the training configuration and/or to trigger the collection and transfer of training may also be included, e.g., in form of a flag or field, in the training configuration communicated at 1308.

At 1312, the UE 1304 obtains, from the network entity 1302, one or more reference signals associated with one or more transmit beams (e.g., the second set of beams 662). The reference signals may be or include SSB(s), CSI-RS(s), DMRS(s), or the like. The UE 1304 may obtain the reference signal(s) using various receive beams (e.g., the first set of beams 660) to perform a beam sweep across various transmit-receive beam pairs (e.g., combinations of transmit-receive beams among the first set of beams 660 and the second set of beams 662). The UE 1304 may measure one or more channel properties associated with the transmit-receive beam pairs. The channel property measurements may serve as labels and/or ground truths for training an ML model.

At 1314, the UE 1304 obtains perception information associated with the channel property measurements for the reference signal(s). As an example, at a first time instance, the UE 1304 is located at first position, for example, near the network entity 1302. The UE 1304 obtains channel measurements associated with multiple transmit-receive beam pairs and also obtains the position and orientation of the UE 1304 at the first position based on the perception information. At a second time instance, the UE 1304 moves to a second position, for example, far from the network entity 1302. The UE 1304 obtains channel measurements associated with multiple transmit-receive beam pairs and also obtains the position and orientation of the UE 1304 at the second position based on the perception information. For example, the UE 1304 may capture one or more images using a camera, and the perception information may include the image(s).

At 1316, the UE 1304 sends, to the model server 1350 (for example, via the network entity 1302), training data associated with an ML model, such as the training data 1202 of FIG. 12. The training data may include the channel property measurements (which may be or include label(s)), the perception information in a local coordinate system of the UE 1304, beam information, and translation information for the local coordinate system (e.g., an indication of the UE position/orientation in a global or common coordinate system). The channel property measurement may include RSRP value(s) (e.g., RSRP[n] at time instance n) associated with a transmit-receive beam pair. The channel property measurements may include measurement values for any of the channel properties described herein. The perception information for training may include a position (e.g., t_{6dof}[n] at time instance n) and/or orientation (e.g., R_{6dof}[n] at time instance n) of the UE 1304 in the local coordinate system. The beam information may include a transmit beam information associated with the network entity 1302 and/or receive beam information associated with the UE 1304. As an example, the beam information may include a transmit beam identifier (e.g., BeamID_{gnb}[n] at time instance n such as a reference signal resource identifier) and/or receive beam vector (e.g., f_{6dof}[n] at time instance n) in the local coordinate system, for example, as described herein with respect to FIG. 10. The indication of the UE position in the global coordinate system may include the image captured at the UE 1304 (e.g., Image[n] at time instance n) or any other suitable positioning information, for example, obtained via a global navigation satellite system and/or wireless local area network (WLAN) positioning. In certain aspects, training data may include a time series of training data collected at multiple time instances for batched training.

In certain aspects, the receive beam information may include a receive beam identifier that identifies a specific receive beam used by the UE 1304. In certain aspects, the receive beam vector may be translated into the local coordinate system associated with an XR device, for example, if the RF transceiver of the UE 1304 is displaced from the XR device.

At 1318, the model server 1350 trains an ML model for perception-aided wireless communications, for example, as described herein with respect to FIG. 12. In certain aspects, the model server 1350 may determine the rotation matrix and/or translation vector to convert the local coordinate system of the UE 1304 to a global or common coordinate system, for example, as described herein with respect to Expressions (1) and (2). As an example, the model server 1350 may use visual positioning system (VPS) techniques to determine the rotation matrix and/or translation vector based on the image(s) obtained from the UE 1304. The model server 1350 may convert the training data from the local coordinate system of the UE 1304 to the global coordinate system, and the model server 1350 may use the training data in the global coordinate system to train the ML model.

At 1320, the UE 1304 obtains, from the model server 1350, ML model information for perception-aided wireless communications. In certain cases, the ML model information may include the ML model trained at 1318 or a suitable version or approximation of the ML model. In certain aspects, the ML model may be trained and/or configured for execution by or at the UE 1304. In certain cases, the ML model information may include or more parameters (e.g., models weights and/or a model structure) to reproduce the ML model trained at 1318 or an approximation thereof. In certain aspects, ML model information may include an indication of the rotation matrix and/or translation vector to convert the local coordinate system of the UE 1304 to a global or common coordinate system.

At 1322, the UE 1304 obtains, from the network entity 1302, an indication to activate the trained ML model for perception-aided wireless communications. For example, the activation indication for the ML model may be communicated via RRC signaling, MAC signaling, DCI, or the like. In certain cases, the ML model information communicated at 1320 may include the indication to active the trained ML model.

At 1324, the UE 1304 communicates with the network entity 1302 in a perception-aided manner based on the activated ML model and perception information, for example, as described herein with respect to FIG. 9. The UE 1304 may perform beam management operations (e.g., as described herein with respect to FIG. 8) using the ML model to provide channel property predictions associated with beams. As an example, the UE may perform a virtual beam sweep using the ML model to determine predictions for channel properties associated with multiple transmit-receive beam pairs (e.g., combinations of transmit-receive beams among the first set of beams 660 and the second set of beams 662). The UE 1304 may select a transmit-receive beam pair that has a predicted channel property with the strongest channel quality and/or strength among the channel property predictions obtained via the ML model. The UE 1304 may communicate with the network entity 1302 via the selected transmit-receive beam pair. In certain aspects, the ML model may be retrained as further described herein with respect to FIG. 15.

### Example Signaling Related to ML Model Deployment for Perception-Aided Wireless Communications

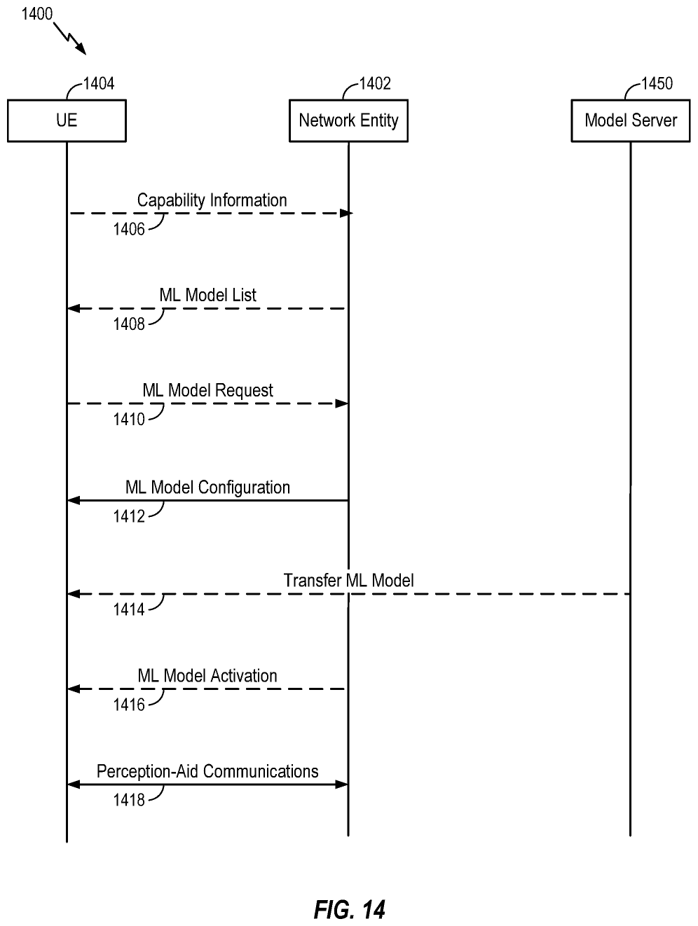

FIG. 14 depicts a process flow 1400 for ML model deployment for perception-aided wireless communications in a network between a network entity 1402, a user equipment (UE) 1404, and model server 1450. In some aspects, the network entity 1402 may be an example of the BS 102 depicted and described with respect to FIGS. 1 and 3 or a disaggregated base station depicted and described with respect to FIG. 2. Similarly, the UE 1404 may be an example of UE 104 depicted and described with respect to FIGS. 1 and 3. However, in other aspects, UE 1404 may be another type of wireless communications device and network entity 1402 may be another type of network entity or network node, such as those described herein. In certain aspects, the model server 1450 may be in communication with the UE 1404 via the network entity 1402. In certain aspects, the model server 1450 may be integrated with the network entity 1402 and/or an example of a disaggregated entity of a base station, for example, as described herein with respect to FIG. 13. Note that any operations or signaling illustrated with dashed lines may indicate that that operation or signaling is an optional or alternative example.

In this example, an ML model may be trained to predict channel properties based on perception information, for example, as described herein with respect to FIGS. 9 and 13.

At 1406, the UE 1404 sends, to the network entity 1402, capability information that indicates ML capabilities of the UE associated with perception-aided wireless communications. The capability information may indicate or include a type of input data (e.g., perception information) that the UE is capable of feeding to an ML model for perception-based channel property predictions. The capability information may indicate or include the types of sensor(s) that the UE has to generate (and/or has access to obtain) perception information (e.g., camera(s), IMU, etc.) and/or the type of perception information that can be generated from such sensor(s) (e.g., position, orientation, and/or image(s)).

At 1408, the UE 1404 obtains, from the network entity 1402, a list of ML models that can be used for AI-enhanced wireless communications and obtained from the model server 1450. In certain aspects, the list of ML models may be based on the capability information communicated at 1406. For example, the list of ML models may be a subset of ML models hosted or available at the model server 1450, and the UE may be capable of using the subset of ML models in accordance with the capability information. In certain aspects, the list of ML models may include a list of ML model identifiers and/or ML feature or function names. The list of ML models may indicate that there is an ML model trained to predict channel properties based on perception information.

At 1410, the UE 1404 sends, to the network entity 1402, a request to use one or more of the ML models identified in the list. The UE 1404 may identify a set of ML models that the UE can support among the list of ML models obtained at 1408, and the UE 1404 may notify the network entity 1402 of the supported ML model(s), which may include the ML model trained to predict channel properties based on perception information.

At 1412, the UE 1404 obtains, from the network entity 1402, a configuration for AI-based channel property prediction via perception information. The configuration may indicate to the UE 1404 to predict at least one channel property, based at least in part on perception information, using an ML model. In certain aspects, the UE 1404 may determine the ML model to use for channel property prediction based at least in part on the configuration. For example, the configuration may indicate or include a specific ML model, parameter(s) to reproduce the ML model, and/or an indication of the ML model to use for channel property prediction. The configuration may explicitly or implicitly indicate the ML model to use for channel property predication. In certain aspects, the configuration may indicate to the UE 1404 to refrain from or reduce the monitoring of certain reference signal(s) associated with beams, which may enable energy savings and/or efficient channel usage for wireless communications. In certain aspects, the configuration may indicate to refrain from or reduce transmission of feedback associated with the reference signals, which may also enable energy savings and/or efficient channel usage for wireless communications.

At 1414, the UE 1404 obtains, from the model server 1450, a specific ML model associated with the configuration obtained at 1412. As an example, the UE 1404 may request a specific ML model from the model server 1450, for example, when the specific model is not yet deployed at or on the UE 1404. In some aspects, the network entity 1402 may trigger deployment of the specific ML model from the model server 1450, for example, as a part of communicating the configuration at 1412. In some cases, the specific ML model may be deployed at the UE 1404, and thus, the UE 1404 may refrain from obtaining the specific ML model from the model server 1450. In certain aspects, the UE 1404 may obtain a rotation matrix and/or translation vector to convert the local coordinate system of the UE to a global or common coordinate system.

At 1416, the UE 1404 obtains, from the network entity 1402, an indication to activate the ML model for perception-aided wireless communications. For example, the activation indication for the ML model may be communicated via RRC signaling, MAC signaling, and/or DCI. In certain aspects, the configuration communicated at 1412 may include the activation indication.

At 1418, the UE 1404 communicates with the network entity 1402 based on perception information, for example, as described herein with respect to FIG. 9 and/or FIG. 13. The UE 1404 may perform beam management operations (e.g., as described herein with respect to FIG. 8) using the ML model to provide channel property predictions associated with beams. As the perception-aided wireless communications may be performed without measurement of reference signal(s) and any feedback thereof, the perception-aided wireless communications may enable reduced channel usage for reference signal transmissions and/or any feedback associated with the reference signals.

### Example Signaling Related to ML Model LCM for Perception-Aided Wireless Communications

FIG. 15 depicts a process flow 1500 for lifecycle management (LCM) of an ML model configured for perception-aided wireless communications in a network between a network entity 1502, a user equipment (UE) 1504, and a model server 1550. In some aspects, the network entity 1502 may be an example of the BS 102 depicted and described with respect to FIGS. 1 and 3 or a disaggregated base station depicted and described with respect to FIG. 2. Similarly, the UE 1504 may be an example of UE 104 depicted and described with respect to FIGS. 1 and 3. The model server 1550 may be an example of the model server 650 depicted and described with respect to FIG. 6. However, in other aspects, UE 1504 may be another type of wireless communications device, and network entity 1502 may be another type of network entity or network node, such as those described herein.

In certain aspects, the model server 1550 may be in communication with the UE 1504 via the network entity 1502. In certain aspects, the model server 1550 may be integrated with the network entity 1502 and/or an example of a disaggregated entity of a base station, for example, as described herein with respect to FIG. 13. Note that any operations or signaling illustrated with dashed lines may indicate that that operation or signaling is an optional or alternative example.

In this example, one or more ML models may be deployed at the UE 1504. For example, the UE 1504 may obtain a first ML model according to the operations described herein with respect to FIG. 13 and/or FIG. 14. The first ML model may be trained to predict a channel property based on perception information, for example, as described herein with respect to FIGS. 9 and 10.

At 1506, the UE 1504 obtains, from the network entity 1502, a configuration that indicates lifecycle management (LCM) operation(s) for the first ML model. The configuration may indicate to the UE to monitor and/or report the performance of the first ML model. The configuration may indicate certain reference signals to measure for ground truth comparisons with the ML predictions. The configuration may indicate one or more states that trigger certain LCM task(s), such as collection and transferring of training data to the model server 1550, ML model deactivation, and/or reporting performance metric(s) (e.g., an error, accuracy, and/or predicted value) associated with predicting channel properties via the first ML model. The configuration may indicate an environment and/or an area in which the first ML model is valid or compatible. The area may be indicated by a tracking area and/or a list of one or more network entities (e.g., as serving cell or gNB identifiers) that provide cell coverage in the area. The configuration may indicate a duration of time for which the first ML model is valid. The configuration may be communicated via RRC signaling, MAC signaling, DCI, and/or system information.

As an example, when the RSRP prediction accuracy falls below a certain threshold (e.g., Y dB), the UE 1504 may be configured to deactivate perception-aided RSRP prediction and fallback to the beam management based on reference signal measurements.

As another example, when the RSRP prediction accuracy falls below a certain threshold (e.g., Z dB), the UE 1504 may be configured to collect training data and send the training data to the model server 1550 to update and/or retrain the ML model.

As another example, the UE 1504 may be configured to notify the network entity 1502 when there is a change in the environment in which the first ML model is configured to provide predictions. In some cases, the change in environment may be determined based on an error between the channel property prediction and a ground truth channel property measurement. For example, suppose there is construction or remodeling that occurs in the coverage area of the network entity 1502, such that a new object (e.g., a new piece of furniture) or structure (e.g., a new building) causes signal reflections and/or diffraction at certain positions in the coverage area, resulting in lower than expected signal strengths at those positions. As another example, suppose an object or structure that previously caused signal reflections and/or diffraction is removed from the coverage area, resulting in higher than expected signal strengths at certain positions. Accordingly, the training of the ML model may not account for the change in the environment, and the notification of the change by the UE 1504 may trigger the ML model to be retrained or reconfigured at the model server 1550.

In certain aspects, the change in the environment may occur when the UE 1504 moves to a different environment, such as a different coverage area associated with the network entity 1502 or a different network entity. The change in the environment may be determined based on the position and/or orientation of the UE 1504.

At 1508, the UE 1504 obtains, from the network entity 1502, one or more signals (e.g., reference signals) for monitoring the performance of the first ML model based on the configuration obtained at 1506. The UE 1504 may obtain channel property measurements associated with transmit-receive beam pairs, where the channel property measurements may serve as ground truths for determining a performance metric (e.g., an error or accuracy) associated with the predictions of the first ML model. The UE 1504 may obtain the measurements of the reference signals on a periodic, semi-persistent, and/or aperiodic basis. The UE 1504 may obtain the measurements of the reference signals based on a trigger state of the configuration.

The UE 1504 may obtain the measurements of the reference signals less frequently compared to real-time tracking of channel properties based on the reference signals. The network entity 1502 may allocate a small portion of available resources to reference signals (e.g., every 160 ms) to enable the UE 1504 to determine ground-truth beam measurements. Since the purpose of the reference signals is not to track channel properties in real-time, but provide a ground-truth beam measurement for monitoring the ML model performance, the reference signal overhead may be very small, e.g., every 160 ms. Accordingly, the UE 1504 may monitor the reference signals with a first periodicity that is greater in duration than a second periodicity used for tracking channel properties based on measurements of the reference signals.

At 1510, the UE 1504 sends, to the network entity 1502, a performance report associated with the predictions of the first ML model. The performance report may indicate or include one or more performance metrics associated with predicting the one or more channel properties via the first ML model. The performance metric may be or include an error, an accuracy, a latency, and/or a prediction associated with the first ML model. The performance report may indicate or include a mean squared error (MSE) between the ground truth channel property (measured or determined based on the reference signal measurements) and the predicted channel property output by the first ML model. The performance report may indicate or include the prediction accuracy and/or the prediction latency associated with the first ML model. The performance report may indicate or include an indication of whether the first ML model is incompatible with an environment (or area) in which the UE 1504 is positioned. For example, the first ML model may be trained to predict channel properties of a specific coverage area of the network entity 1502, and if the UE 1504 leaves that coverage area to a different coverage area (e.g., the UE 1504 is outside an area associated with the first ML model), the first ML model may be incompatible with the different coverage area. The UE 1504 may send the performance report based on the configuration obtained at 1506. In certain aspects, the UE 1504 may send the performance report when a trigger state is detected, for example, when the MSE or prediction accuracy falls below a certain threshold and/or when the prediction latency exceeds a certain threshold.

As an example, when the predicted RSRP output by the first ML model falls below a certain threshold (e.g., X dB), the UE 1504 may send, to the network entity 1502, the performance report, which may trigger the network entity 1502 to schedule ground-truth measurements, ML model deactivation, and/or ML training.

At 1512, the UE 1504 sends, to the model server 1550, training data based on the configuration obtained at 1506. In certain aspects, the UE 1504 may send the training data when a trigger state is detected, for example, when the MSE or prediction accuracy falls below a certain threshold and/or when the prediction latency exceeds a certain threshold.

At 1514, the UE 1504 deactivates the first ML model based on the configuration obtained at 1506. In certain aspects, the UE 1504 may deactivate the first ML model when a trigger state is detected, for example, when the MSE or prediction accuracy falls below a certain threshold. In certain aspects, the UE 1504 may switch to a different ML model and/or fallback to performing beam management operations based on reference signal measurements.

At 1516, the model server 1550 trains a second ML model based on the training data obtained at 1512, for example, as described herein with respect to FIG. 12.

At 1518, the UE 1504 obtains, from the model server 1550, the second ML model trained based on the training data.

At 1520, the UE 1504 obtains, from the network entity 1502, an indication to activate the second ML model for perception-aided wireless communications. In certain aspects, the UE 1504 obtains, from the network entity 1502, an indication to deactivate the first ML model, for example, based on the performance report sent at 1510. For example, the network entity 1502 may determine that the accuracy of the predictions output by the first ML model is below a threshold based on the performance report, and the network entity 1502 may send the deactivation indication for the first ML model in response to the performance report. The activation/deactivation indication for the ML model may be communicated via RRC signaling, MAC signaling, and/or DCI.

At 1522, the UE 1504 communicates with the network entity 1502 based on perception information, for example, as described herein with respect to FIG. 9. The UE 1504 may perform beam management operations (e.g., as described herein with respect to FIG. 8) using the ML model to provide channel property predictions associated with beams. As the LCM schemes discussed above ensure an ML model is used when the ML model is providing accurate predictions, the ML model may provide channel property predictions that enable improved wireless communication performance, such as increased data rates, reduced latencies, and/or efficient channel usage.

### Example Operations of Perception-Aided Wireless Communications

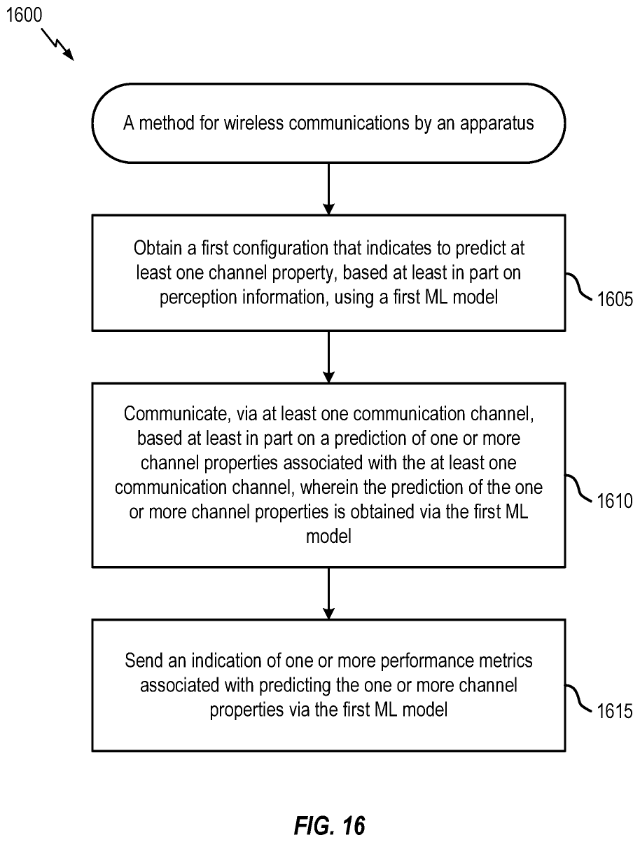

FIG. 16 shows a method 1600 for wireless communications by an apparatus, such as UE 104 of FIGS. 1 and 3.

Method 1600 begins at block 1605 with obtaining a first configuration that indicates to predict at least one channel property, based at least in part on perception information, using a first ML model. In certain aspects, the perception information comprises pose information. In certain aspects, the pose information comprises one or more of: positioning information (e.g., the position information 914) or orientation information (e.g., the orientation information 916).

Method 1600 then proceeds to block 1610 with communicating, via at least one communication channel (e.g., a transmit-receive beam pair), based at least in part on a prediction of one or more channel properties associated with the at least one communication channel, wherein the prediction of the one or more channel properties is obtained via the first ML model.

Method 1600 then proceeds to block 1615 with sending an indication of one or more performance metrics associated with predicting the one or more channel properties via the first ML model.

In certain aspects, method 1600 further includes obtaining one or more reference signals, wherein block 1615 includes sending the indication of the one or more performance metrics based at least in part on one or more measurements of the one or more reference signals. In certain aspects, block 1615 includes sending the indication of the one or more performance metrics based at least in part on a comparison between the one or more measurements of the one or more reference signals and the prediction of the one or more channel properties. In certain aspects, block 1615 includes sending the indication of the one or more performance metrics in response to the comparison satisfying a threshold.

In certain aspects, method 1600 further includes obtaining a second configuration that indicates to report the one or more performance metrics associated with the first ML model.

In certain aspects, method 1600 further includes obtaining a second configuration that indicates one or more states that trigger deactivation of the first ML model. In certain aspects, method 1600 further includes deactivating the first ML model in response to at least one state of the one or more states being detected. In certain aspects, the one or more states comprise one or more of: a first state that occurs when an accuracy associated with the prediction satisfies a first threshold (e.g., when the accuracy is less than or equal to the first threshold); or a second state that occurs when the prediction of the one or more channel properties satisfies a second threshold (e.g., when the prediction is less than or equal to the second threshold).

In certain aspects, method 1600 further includes obtaining a second configuration that indicates one or more states that trigger communication of training data associated with the first ML model. In certain aspects, the one or more states comprise one or more of: a first state that occurs when an accuracy associated with the prediction satisfies a first threshold; or a second state that occurs when the prediction of the one or more channel properties satisfies a second threshold. In certain aspects, method 1600 further includes obtaining one or more reference signals. In certain aspects, method 1600 further includes sending training data associated with the first ML model in response to at least one state of the one or more states being detected, the training data being based at least in part on one or more measurements of the one or more reference signals. In certain aspects, the training data comprises one or more of: the perception information, an indication of a channel property of a communication channel, or translation information for the perception information.

In certain aspects, method 1600 further includes obtaining a second ML model trained based on the training data, e.g., via receiving the second ML model from a network entity or via receiving parameters for reconstructing the second ML model or an approximation thereof at the UE apparatus. In certain aspects, method 1600 further includes receiving an indication to predict the at least one channel property, based at least in part on the perception information, using the second ML model.

In certain aspects, method 1600 further includes receiving a second configuration that indicates one or more states that trigger communication of an indication that the first ML model is incompatible with an environment in which the apparatus is positioned. In certain aspects, the one or more states comprises a first state that occurs when the apparatus is positioned outside of an area associated with the first ML model. In certain aspects, method 1600 further includes sending the indication that the first ML model is incompatible with the environment in response to the one or more states being detected. In certain aspects, method 1600 further includes obtaining an indication to deactivate the first ML model.

In certain aspects, block 1615 includes sending the indication of the one or more performance metrics based at least in part on the prediction of one or more channel properties satisfying a threshold.

In certain aspects, method 1600 further includes providing, to the first ML model, input data comprising the perception information. In certain aspects, method 1600 further includes obtaining, from the first ML model, output data comprising the prediction of the one or more channel properties associated with the at least one communication channel.

In certain aspects, method 1600 further includes searching for the at least one communication channel among a plurality of communication channels based at least in part on the output data.

In certain aspects, method 1600 further includes sending training data associated with the first ML model, wherein the training data comprises one or more of: the perception information, an indication of a channel property of a communication channel, or translation information (e.g., an image) for the perception information. The translation information may indicate a position and/or an orientation of the UE in a global coordinate system to determine the rotation matrix and/or translation vector. In certain aspects, method 1600 further includes obtaining the first ML model trained based on the training data.

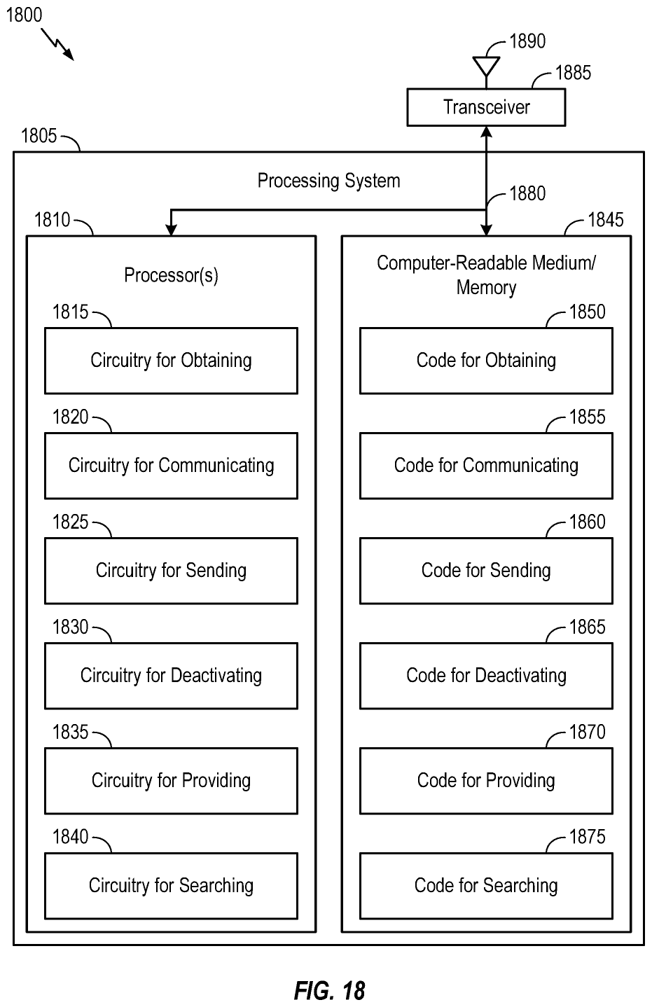

In certain aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

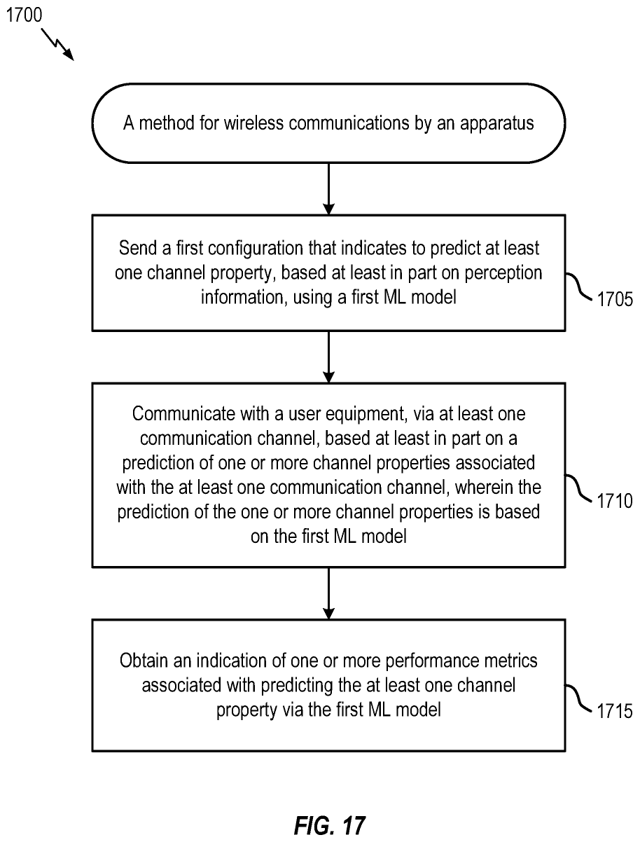

FIG. 17 shows a method 1700 for wireless communications by an apparatus, such as BS 102 of FIGS. 1 and 3, or a disaggregated base station as discussed with respect to FIG. 2.

Method 1700 begins at block 1705 with sending a first configuration that indicates to predict at least one channel property, based at least in part on perception information, using a first ML model. In certain aspects, the perception information comprises pose information. In certain aspects, the pose information comprises one or more of: positioning information or orientation information.

Method 1700 then proceeds to block 1710 with communicating with a user equipment, via at least one communication channel (e.g., a transmit-receive beam pair), based at least in part on a prediction of one or more channel properties associated with the at least one communication channel, wherein the prediction of the one or more channel properties is based on the first ML model.

Method 1700 then proceeds to block 1715 with obtaining an indication of one or more performance metrics associated with predicting the at least one channel property via the first ML model.

In certain aspects, method 1700 further includes sending one or more reference signals, wherein block 1715 includes obtaining the indication of the one or more performance metrics based at least in part on one or more measurements of the one or more reference signals. In certain aspects, block 1715 includes obtaining the indication of the one or more performance metrics based at least in part on a comparison between the one or more measurements of the one or more reference signals and the prediction of the one or more channel properties. In certain aspects, block 1715 includes obtaining the indication of the one or more performance metrics in response to the comparison satisfying a threshold.

In certain aspects, method 1700 further includes sending a second configuration that indicates to report the one or more performance metrics associated with the first ML model.

In certain aspects, method 1700 further includes sending a second configuration that indicates one or more states that trigger deactivation of the first ML model at the user equipment. In certain aspects, the one or more states comprise one or more of: a first state that occurs when an accuracy associated with the prediction satisfies a first threshold; or a second state that occurs when the prediction of the one or more channel properties satisfies a second threshold.

In certain aspects, method 1700 further includes sending a second configuration that indicates one or more states that trigger communication of training data associated with the first ML model. In certain aspects, the one or more states comprise one or more of: a first state that occurs when an accuracy associated with the prediction satisfies a first threshold; or a second state that occurs when the prediction of the one or more channel properties satisfies a second threshold. In certain aspects, method 1700 further includes sending one or more reference signals. In certain aspects, method 1700 further includes obtaining training data associated with the first ML model based on the second configuration, the training data being based at least in part on one or more measurements of the one or more reference signals. In certain aspects, the training data comprises one or more of: the perception information, an indication of a channel property of a communication channel, or translation information for the perception information. In certain aspects, method 1700 further includes sending a second ML model trained based on the training data. In certain aspects, method 1700 further includes sending an indication to predict the at least one channel property, based at least in part on the perception information, using the second ML model.

In certain aspects, method 1700 further includes sending a second configuration that indicates one or more states that trigger communication of an indication that the first ML model is incompatible with an environment in which the user equipment is positioned. In certain aspects, the one or more states comprise a first state that occurs when the user equipment is positioned outside of an area associated with the first ML model. In certain aspects, method 1700 further includes obtaining the indication that the first ML model is incompatible with the environment based on the second configuration. In certain aspects, method 1700 further includes sending an indication to deactivate the first ML model.

In certain aspects, block 1715 includes obtaining the indication of the one or more performance metrics based at least in part on the prediction of one or more channel properties satisfying a threshold.

In certain aspects, method 1700 further includes obtaining training data associated with the first ML model, wherein the training data comprises one or more of: the perception information, an indication of a channel property of a communication channel, or translation information for the perception information. In certain aspects, method 1700 further includes sending the first ML model trained based on the training data.

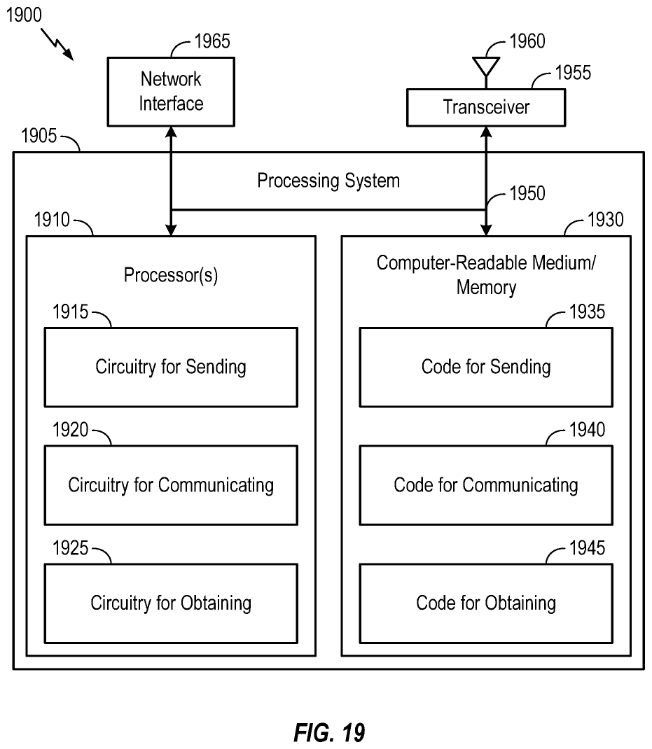

In certain aspects, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative operations are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to a transceiver 1885 (e.g., a transmitter and/or a receiver). The transceiver 1885 is configured to transmit and receive signals for the communications device 1800 via an antenna 1890, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1845 via a bus 1880. In certain aspects, the computer-readable medium/memory 1845 is configured to store instructions (e.g., computer-executable code) that when executed by the one or more processors 1810, enable and cause the one or more processors 1810 to perform the method 1600 described with respect to FIG. 16, or any aspect related to it, including any operations described in relation to FIG. 16. Note that reference to a processor performing a function of communications device 1800 may include one or more processors performing that function of communications device 1800, such as in a distributed fashion.

In the depicted example, computer-readable medium/memory 1845 stores code for obtaining 1850, code for communicating 1855, code for sending 1860, code for deactivating 1865, code for providing 1870, and code for searching 1875. Processing of the code 1850-1875 may enable and cause the communications device 1800 to perform the method 1600 described with respect to FIG. 16, or any aspect related to it.

The one or more processors 1810 include circuitry configured to implement (e.g., execute) the code stored in the computer-readable medium/memory 1845, including circuitry for obtaining 1815, circuitry for communicating 1820, circuitry for sending 1825, circuitry for deactivating 1830, circuitry for providing 1835, and circuitry for searching 1840. Processing with circuitry 1815-1840 may enable and cause the communications device 1800 to perform the method 1600 described with respect to FIG. 16, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1885 and/or antenna 1890 of the communications device 1800 in FIG. 18, and/or one or more processors 1810 of the communications device 1800 in FIG. 18. Means for communicating, receiving, or obtaining may include the transceivers 354, antenna(s) 352, receive processor 358, AI processor 370, and/or controller/processor 380 of the UE 104 illustrated in FIG. 3, transceiver 1885 and/or antenna 1890 of the communications device 1800 in FIG. 18, and/or one or more processors 1810 of the communications device 1800 in FIG. 18. Means for deactivating, providing, or searching may include AI processor 370, and/or controller/processor 380 of the UE 104 illustrated in FIG. 3, and/or one or more processors 1810 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to a transceiver 1955 (e.g., a transmitter and/or a receiver) and/or a network interface 1965. The transceiver 1955 is configured to transmit and receive signals for the communications device 1900 via an antenna 1960, such as the various signals as described herein. The network interface 1965 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1930 via a bus 1950. In certain aspects, the computer-readable medium/memory 1930 is configured to store instructions (e.g., computer-executable code) that when executed by the one or more processors 1910, enable and cause the one or more processors 1910 to perform the method 1700 described with respect to FIG. 17, or any aspect related to it, including any operations described in relation to FIG. 17. Note that reference to a processor of communications device 1900 performing a function may include one or more processors of communications device 1900 performing that function, such as in a distributed fashion.

In the depicted example, the computer-readable medium/memory 1930 stores code for sending 1935, code for communicating 1940, and code for obtaining 1945. Processing of the code 1935-1945 may enable and cause the communications device 1900 to perform the method 1700 described with respect to FIG. 17, or any aspect related to it.

The one or more processors 1910 include circuitry configured to implement (e.g., execute) the code stored in the computer-readable medium/memory 1930, including circuitry for sending 1915, circuitry for communicating 1920, and circuitry for obtaining 1925. Processing with circuitry 1915-1925 may enable and cause the communications device 1900 to perform the method 1700 described with respect to FIG. 17, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1955, antenna 1960, and/or network interface 1965 of the communications device 1900 in FIG. 19, and/or one or more processors 1910 of the communications device 1900 in FIG. 19. Means for communicating, receiving or obtaining may include the transceivers 332, antenna(s) 334, receive processor 338, AI processor 318, and/or controller/processor 340 of the BS 102 illustrated in FIG. 3, transceiver 1955, antenna 1960, and/or network interface 1965 of the communications device 1900 in FIG. 19, and/or one or more processors 1910 of the communications device 1900 in FIG. 19.

### EXAMPLE CLAUSES

Implementation examples are described in the following numbered clauses:

Clause 1: A method for wireless communications by an apparatus comprising: obtaining a first configuration that indicates to predict at least one channel property, based at least in part on perception information, using a first ML model; communicating, via at least one communication channel, based at least in part on a prediction of one or more channel properties associated with the at least one communication channel, wherein the prediction of the one or more channel properties is obtained via the first ML model; and sending an indication of one or more performance metrics associated with predicting the one or more channel properties via the first ML model.

Clause 2: The method of Clause 1, further comprising obtaining one or more reference signals, wherein sending the indication of the one or more performance metrics comprises sending the indication of the one or more performance metrics based at least in part on one or more measurements of the one or more reference signals.

Clause 3: The method of Clause 2, wherein sending the indication of the one or more performance metrics comprises sending the indication of the one or more performance metrics based at least in part on a comparison between the one or more measurements of the one or more reference signals and the prediction of the one or more channel properties.

Clause 4: The method of Clause 3, wherein sending the indication of the one or more performance metrics comprises sending the indication of the one or more performance metrics in response to the comparison satisfying a threshold.

Clause 5: The method of any one of Clauses 1-4, further comprising obtaining a second configuration that indicates to report the one or more performance metrics associated with the first ML model.

Clause 6: The method of any one of Clauses 1-5, further comprising obtaining a second configuration that indicates one or more states that trigger deactivation of the first ML model.

Clause 7: The method of Clause 6, further comprising deactivating the first ML model in response to at least one state of the one or more states being detected.

Clause 8: The method of Clause 6 or 7, wherein the one or more states comprise one or more of: a first state that occurs when an accuracy associated with the prediction satisfies a first threshold; or a second state that occurs when the prediction of the one or more channel properties satisfies a second threshold.

Clause 9: The method of any one of Clauses 1-8, further comprising obtaining a second configuration that indicates one or more states that trigger communication of training data associated with the first ML model.

Clause 10: The method of Clause 9, further comprising: obtaining one or more reference signals; and sending training data associated with the first ML model in response to at least one state of the one or more states being detected, the training data being based at least in part on one or more measurements of the one or more reference signals.

Clause 11: The method of Clause 9 or 10, wherein the training data comprises one or more of: the perception information, an indication of a channel property of a communication channel, or translation information for the perception information.

Clause 12: The method of Clause 10 or 11, further comprising: obtaining a second ML model trained based on the training data; and obtaining an indication to predict the at least one channel property, based at least in part on the perception information, using the second ML model.

Clause 13: The method of any one of Clauses 9-12, wherein the one or more states comprise one or more of: a first state that occurs when an accuracy associated with the prediction satisfies a first threshold; or a second state that occurs when the prediction of the one or more channel properties satisfies a second threshold.

Clause 14: The method of any one of Clauses 1-13, further comprising obtaining a second configuration that indicates one or more states that trigger communication of an indication that the first ML model is incompatible with an environment in which the apparatus is positioned.

Clause 15: The method of Clause 14, further comprising: sending the indication that the first ML model is incompatible with the environment in response to the one or more states being detected; and obtaining an indication to deactivate the first ML model.

Clause 16: The method of Clause 14 or 15, wherein the one or more states comprises a first state that occurs when the apparatus is positioned outside of an area associated with the first ML model.

Clause 17: The method of any one of Clauses 1-16, wherein sending the indication of the one or more performance metrics comprises sending the indication of the one or more performance metrics based at least in part on the prediction of one or more channel properties satisfying a threshold.

Clause 18: The method of any one of Clauses 1-17, further comprising: providing, to the first ML model, input data comprising the perception information; and obtaining, from the first ML model, output data comprising the prediction of the one or more channel properties associated with the at least one communication channel.

Clause 19: The method of Clause 18, further comprising searching for the at least one communication channel among a plurality of communication channels based at least in part on the output data.

Clause 20: The method of Clause 18 or 19, wherein the perception information comprises pose information.

Clause 21: The method of Clause 20, wherein the pose information comprises one or more of: positioning information or orientation information.

Clause 22: The method of any one of Clauses 1-21, further comprising: sending training data associated with the first ML model, wherein the training data comprises one or more of: the perception information, an indication of a channel property of a communication channel, or translation information for the perception information; and obtaining the first ML model trained based on the training data.

Clause 23: A method for wireless communications by an apparatus comprising: sending a first configuration that indicates to predict at least one channel property, based at least in part on perception information, using a first ML model; communicating with a user equipment, via at least one communication channel, based at least in part on a prediction of one or more channel properties associated with the at least one communication channel, wherein the prediction of the one or more channel properties is based on the first ML model; and obtaining an indication of one or more performance metrics associated with predicting the at least one channel property via the first ML model.

Clause 24: The method of Clause 23, further comprising sending one or more reference signals, wherein obtaining the indication of the one or more performance metrics comprises obtaining the indication of the one or more performance metrics based at least in part on one or more measurements of the one or more reference signals.

Clause 25: The method of Clause 24, wherein obtaining the indication of the one or more performance metrics comprises obtaining the indication of the one or more performance metrics based at least in part on a comparison between the one or more measurements of the one or more reference signals and the prediction of the one or more channel properties.

Clause 26: The method of Clause 25, wherein obtaining the indication of the one or more performance metrics comprises obtaining the indication of the one or more performance metrics in response to the comparison satisfying a threshold.

Clause 27: The method of any one of Clauses 23-26, further comprising sending a second configuration that indicates to report the one or more performance metrics associated with the first ML model.

Clause 28: The method of any one of Clauses 23-27, further comprising sending a second configuration that indicates one or more states that trigger deactivation of the first ML model at the user equipment.

Clause 29: The method of Clause 28, wherein the one or more states comprise one or more of: a first state that occurs when an accuracy associated with the prediction satisfies a first threshold; or a second state that occurs when the prediction of the one or more channel properties satisfies a second threshold.

Clause 30: The method of any one of Clauses 23-29, further comprising sending a second configuration that indicates one or more states that trigger communication of training data associated with the first ML model.

Clause 31: The method of Clause 30, further comprising: sending one or more reference signals; and obtaining training data associated with the first ML model based on the second configuration, the training data being based at least in part on one or more measurements of the one or more reference signals.

Clause 32: The method of Clause 31, wherein the training data comprises one or more of: the perception information, an indication of a channel property of a communication channel, or translation information for the perception information.

Clause 33: The method of Clause 31 or 32, further comprising: sending a second ML model trained based on the training data; and sending an indication to predict the at least one channel property, based at least in part on the perception information, using the second ML model.

Clause 34: The method of any one of Clauses 31-33, wherein the one or more states comprise one or more of: a first state that occurs when an accuracy associated with the prediction satisfies a first threshold; or a second state that occurs when the prediction of the one or more channel properties satisfies a second threshold.

Clause 35: The method of any one of Clauses 23-34, further comprising sending a second configuration that indicates one or more states that trigger communication of an indication that the first ML model is incompatible with an environment in which the user equipment is positioned.

Clause 36: The method of Clause 35, further comprising: obtaining the indication that the first ML model is incompatible with the environment based on the second configuration; and sending an indication to deactivate the first ML model.

Clause 37: The method of Clause 35 or 36, wherein the one or more states comprise a first state that occurs when the user equipment is positioned outside of an area associated with the first ML model.

Clause 38: The method of any one of Clauses 23-37, wherein obtaining the indication of the one or more performance metrics comprises obtaining the indication of the one or more performance metrics based at least in part on the prediction of one or more channel properties satisfying a threshold.

Clause 39: The method of any one of Clauses 23-38, wherein the perception information comprises pose information.

Clause 40: The method of Clause 39, wherein the pose information comprises one or more of: positioning information or orientation information.

Clause 41: The method of any one of Clauses 23-40, further comprising: obtaining training data associated with the first ML model, wherein the training data comprises one or more of: the perception information, an indication of a channel property of a communication channel, or translation information for the perception information; and sending the first ML model trained based on the training data.

Clause 42: A method for wireless communications, carried out at a user equipment (UE) comprising: receiving, from a network entity, configuration information indicating to the UE to predict at least one property of a wireless communication channel, based at least in part on perception information to be obtained by the UE, using a machine learning, ML, model; obtaining the perception information; predicting, based at least in part on the obtained perception information and using the ML model, the at least one property of the wireless communication channel; and wirelessly communicating with a network associated with the network entity based at least in part on the predicted at least one property of the wireless communication channel.

Clause 43: A method for training a machine learning (ML) model for predicting at least one property of a wireless communication channel used by a user equipment (UE) for communicating with a network associated with a network entity, the method comprising: receiving, at the network entity, from the UE, training data for training the ML model, wherein the training data comprises a plurality of perception information obtained by the UE and labeled with corresponding channel property information obtained by the UE and associated with the plurality of perception information; and training, by the network entity and based at least in part on the received training data, the ML model to predict the at least one property of a wireless communication channel based on perception information to be obtained by the UE.

Clause 44: One or more apparatuses, comprising: one or more memories comprising executable instructions; and one or more processors configured to execute the executable instructions and cause the one or more apparatuses to perform a method in accordance with any one of Clauses 1-43.

Clause 45: One or more apparatuses, comprising: one or more memories; and one or more processors, coupled to the one or more memories, configured to cause the one or more apparatuses to perform a method in accordance with any one of Clauses 1-41.

Clause 46: One or more apparatuses, comprising: one or more memories; and one or more processors, coupled to the one or more memories, configured to perform a method in accordance with any one of Clauses 1-43.

Clause 47: One or more apparatuses, comprising means for performing a method in accordance with any one of Clauses 1-43.

Clause 48: One or more non-transitory computer-readable media comprising executable instructions that, when executed by one or more processors of one or more apparatuses, cause the one or more apparatuses to perform a method in accordance with any one of Clauses 1-43.

Clause 49: One or more computer program products embodied on one or more computer-readable storage media comprising code for performing a method in accordance with any one of Clauses 1-43.

Clause 50: A user equipment (UE), comprising: a processing system that includes processor circuitry and memory circuitry that stores code and is coupled with the processor circuitry, the processing system configured to cause the UE to perform a method in accordance with any one of Clauses 1-22 and 42.

Clause 51: A network entity, comprising: a processing system that includes processor circuitry and memory circuitry that stores code and is coupled with the processor circuitry, the processing system configured to cause the network entity to perform a method in accordance with any one of Clauses 23-41 and 43.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first configuration that indicates to predict at least one channel property, based at least in part on perception information, using a first machine learning (ML) model;
communicate, via at least one communication channel, based at least in part on a prediction of one or more channel properties associated with the at least one communication channel, wherein the prediction of the one or more channel properties is obtained via the first ML model; and
send an indication of one or more performance metrics associated with predicting the one or more channel properties via the first ML model.

2. The apparatus of claim 1, wherein:
the one or more processors are configured to cause the apparatus to obtain one or more reference signals; and
to send the indication of the one or more performance metrics, the one or more processors are configured to cause the apparatus to send the indication of the one or more performance metrics based at least in part on one or more measurements of the one or more reference signals.

3. The apparatus of claim 2, wherein to send the indication of the one or more performance metrics, the one or more processors are configured to cause the apparatus to send the indication of the one or more performance metrics based at least in part on a comparison between the one or more measurements of the one or more reference signals and the prediction of the one or more channel properties.

4. The apparatus of claim 1, wherein the one or more processors are configured to cause the apparatus to obtain a second configuration that indicates to report the one or more performance metrics associated with the first ML model.

5. The apparatus of claim 1, wherein the one or more processors are configured to cause the apparatus to obtain a second configuration that indicates one or more states that trigger deactivation of the first ML model.

6. The apparatus of claim 5, wherein the one or more processors are configured to cause the apparatus to deactivate the first ML model in response to at least one state of the one or more states being detected.

7. The apparatus of claim 1, wherein the one or more processors are configured to cause the apparatus to obtain a second configuration that indicates one or more states that trigger communication of training data associated with the first ML model.

8. The apparatus of claim 7, wherein the one or more processors are configured to cause the apparatus to:
obtain one or more reference signals; and
send training data associated with the first ML model in response to at least one state of the one or more states being detected, the training data being based at least in part on one or more measurements of the one or more reference signals.

9. The apparatus of claim 8, wherein the one or more processors are configured to cause the apparatus to:
obtain a second ML model trained based on the training data; and
obtain an indication to predict the at least one channel property, based at least in part on the perception information, using the second ML model.

10. The apparatus of claim 1, wherein the one or more processors are configured to cause the apparatus to obtain a second configuration that indicates one or more states that trigger communication of an indication that the first ML model is incompatible with an environment in which the apparatus is positioned.

11. The apparatus of claim 10, wherein the one or more processors are configured to cause the apparatus to:
send the indication that the first ML model is incompatible with the environment in response to the one or more states being detected; and
obtain an indication to deactivate the first ML model.

12. The apparatus of claim 1, wherein to send the indication of the one or more performance metrics, the one or more processors are configured to cause the apparatus to send the indication of the one or more performance metrics based at least in part on the prediction of the one or more channel properties satisfying a threshold.

13. The apparatus of claim 1, wherein the one or more processors are configured to cause the apparatus to:
provide, to the first ML model, input data comprising the perception information; and
obtain, from the first ML model, output data comprising the prediction of the one or more channel properties associated with the at least one communication channel.

14. The apparatus of claim 13, wherein the one or more processors are configured to cause the apparatus to search for the at least one communication channel among a plurality of communication channels based at least in part on the output data.

15. The apparatus of claim 1, wherein the one or more processors are configured to cause the apparatus to:
send training data associated with the first ML model, wherein the training data comprises one or more of: the perception information, an indication of a channel property of a communication channel, or translation information for the perception information; and
obtain the first ML model trained based on the training data.

16. An apparatus configured for wireless communications, comprising:
one or more memories; and
one or more processors coupled to the one or more memories, the one or more processors being configured to cause the apparatus to:
send a first configuration that indicates to predict at least one channel property, based at least in part on perception information, using a first machine learning (ML) model;
communicate with a user equipment, via at least one communication channel, based at least in part on a prediction of one or more channel properties associated with the at least one communication channel, wherein the prediction of the one or more channel properties is based on the first ML model; and
obtain an indication of one or more performance metrics associated with predicting the at least one channel property via the first ML model.

17. The apparatus of claim 16, wherein:
the one or more processors are configured to cause the apparatus to send one or more reference signals; and
to obtain the indication of the one or more performance metrics, the one or more processors are configured to cause the apparatus to obtain the indication of the one or more performance metrics based at least in part on one or more measurements of the one or more reference signals.

18. The apparatus of claim 17, wherein to obtain the indication of the one or more performance metrics, the one or more processors are configured to cause the apparatus to obtain the indication of the one or more performance metrics based at least in part on a comparison between the one or more measurements of the one or more reference signals and the prediction of the one or more channel properties.

19. The apparatus of claim 16, wherein the one or more processors are configured to cause the apparatus to send a second configuration that indicates to report the one or more performance metrics associated with the first ML model.

20. The apparatus of claim 16, wherein the one or more processors are configured to cause the apparatus to send a second configuration that indicates one or more states that trigger deactivation of the first ML model at the user equipment.

21. The apparatus of claim 16, wherein the one or more processors are configured to cause the apparatus to send a second configuration that indicates one or more states that trigger communication of training data associated with the first ML model.

22. The apparatus of claim 21, wherein the one or more processors are configured to cause the apparatus to:
send one or more reference signals; and
obtain training data associated with the first ML model based on the second configuration, the training data being based at least in part on one or more measurements of the one or more reference signals.

23. The apparatus of claim 22, wherein the one or more processors are configured to cause the apparatus to:
send a second ML model trained based on the training data; and
send an indication to predict the at least one channel property, based at least in part on the perception information, using the second ML model.

24. The apparatus of claim 16, wherein the one or more processors are configured to cause the apparatus to send a second configuration that indicates one or more states that trigger communication of an indication that the first ML model is incompatible with an environment in which the user equipment is positioned.

25. The apparatus of claim 24, wherein the one or more processors are configured to cause the apparatus to:
obtain the indication that the first ML model is incompatible with the environment based on the second configuration; and
send an indication to deactivate the first ML model.

26. The apparatus of claim 16, wherein to obtain the indication of the one or more performance metrics, the one or more processors are configured to cause the apparatus to obtain the indication of the one or more performance metrics based at least in part on the prediction of one or more channel properties satisfying a threshold.

27. The apparatus of claim 16, wherein the one or more processors are configured to cause the apparatus to:
obtain training data associated with the first ML model, wherein the training data comprises one or more of: the perception information, an indication of a channel property of a communication channel, or translation information for the perception information; and
send the first ML model trained based on the training data.

28. A method for wireless communications by an apparatus, comprising:
obtaining a first configuration that indicates to predict at least one channel property, based at least in part on perception information, using a first machine learning (ML) model;
communicating, via at least one communication channel, based at least in part on a prediction of one or more channel properties associated with the at least one communication channel, wherein the prediction of the one or more channel properties is obtained via the first ML model; and
sending an indication of one or more performance metrics associated with predicting the one or more channel properties via the first ML model.

29. A method for wireless communications by an apparatus, comprising:
sending a first configuration that indicates to predict at least one channel property, based at least in part on perception information, using a first machine learning (ML) model;
communicating with a user equipment, via at least one communication channel, based at least in part on a prediction of one or more channel properties associated with the at least one communication channel, wherein the prediction of the one or more channel properties is based on the first ML model; and
obtaining an indication of one or more performance metrics associated with predicting the at least one channel property via the first ML model.
